(19) United States
(12) Patent Application Publication
(10) Pub. No.: US 2021/0394446 A1
(43) Pub. Date: Dec. 23, 2021

(54) METHOD OF ADDITIVE MANUFACTURING OF OBJECT USING OBJECT MATERIAL, OBJECT MANUFACTURED USING THE SAME, AND METHOD OF SCANNING AN OBJECT IDENTIFIER FORMED USING THE SAME

(71) Applicant: SECUR3DP+ PTE. LTD., Singapore (SG)

(72) Inventors: Tuan Anh Tran, Singapore (SG); Chaw Sing Ho, Singapore (SG); David Wine, Singapore (SG); Choon Wee Joel Lim, Singapore (SG); Rahul Koneru, Singapore (SG)

(21) Appl. No.: 17/260,927

(22) PCT Filed: Jul. 19, 2019
(86) PCT No.: PCT/SG2019/050349

§ 371 Date: Jan. 15, 2021

Related U.S. Application Data
(60) Provisional application No. 62/700,538, filed on Jul. 19, 2018.

(51) Int. Cl. B29C 64/386; B33Y 10/00; B33Y 80/00; B33Y 50/00; B22F 10/28; B29C 64/165; B29C 64/124; B22F 10/80; G06K 7/02; G06K 7/10

(52) U.S. Cl. CPC B29C 64/386; B33Y 10/00; B33Y 80/00; B33Y 50/00; G06K 7/1099; B29C 64/165; B29C 64/124; B22F 10/80; G06K 7/02; B22F 10/28

(57) ABSTRACT

According to embodiments of the present invention, a method of additive manufacturing of an object using object material is provided. The method includes forming the object by processing some of the object material, and forming an object identifier by forming a pattern having at least one coded volume within an internal volume of the object, each of the at least one coded volume enclosing unprocessed object material. According to further embodiments of the present invention, an object manufactured using the method of additive manufacturing and a method of scanning an object identifier formed using the method of additive manufacturing are is also provided.

### CROSS-REFERENCE TO RELATED APPLICATION

This application is the U.S. National Stage of International Application No. PCT/SG2019/050349, filed Jul. 19, 2019, which designates the U.S., published in English, and claims the benefit of U.S. Provisional Application No. 62/700,538, filed Jul. 19, 2018. The entire teachings of the above applications are incorporated herein by reference.

### TECHNICAL FIELD

Various embodiments relate to a method of additive manufacturing of an object using object material, an object manufactured using the method of additive manufacturing and a method of scanning an object identifier formed using the method of additive manufacturing.

### BACKGROUND

Inclusion or attachment of identifiers, either in two-dimension (2D) or three-dimension (3D), into produced items involves several processes. These include identifier encoding methodology, and ultra-sound scanning procedure and decoding/readout methodology.

For identifier encoding methodology, the most typical method used to encode information, e.g., characters and numbers, is a presentation of data in one-dimension (1D) using barcodes. A barcode typically consists of printed parallel lines of varying widths and spacing. A two-dimensional (2D) presentation of data typically is implemented using rectangles, dots, or other geometric patterns with varying shapes, positions, and sizes. These 1D and 2D patterns are optically readable by machines and are used as identification for automatically identifying and tracking tags attached to objects. Examples of standards for barcode symbology include the Universal Product Code (UPC) and the International Article Number (EAN). Three-dimensional (3D) barcodes are similar to 2D barcodes except that the lines have measurable depths and thicknesses. The use of 3D barcodes is rather limited and is only useful in the case of severe or harsh environmental conditions in which 2D barcodes are easily destroyed. 3D barcodes are normally engraved directly onto the surface of the product. The common features of these barcodes, despite their dimensional representation, are that they are optically visible and fabricated or attached on the product's surface. As such, instead of being a unique identification of the product, a barcode plays the role of a label, which is not strictly associated with the fabrication process and is also removable.

In relation to the ultra-sound scanning procedure and decoding/readout methodology, ultrasonic scanning is widely used in industrial non-destructive testing, quality control and medical imaging applications. Ultra-sound scanning procedure may involve phased array ultrasonics. The method involves the use of an array of emitters and receivers of ultrasonic waves to image flaws, which contain materials having significantly different sound velocity, e.g., air, in tested products. As the method relies on the sound velocity contrast between media in the propagation direction of ultrasonic waves, it requires elimination of air between the probe and the surface of the scanned product using couplant, which is typically in the form of gel having sound velocity similar to that of the scanned material. The use of couplant between the probe and the scanned product can be eliminated by a more advanced method, namely Electromagnetic Acoustic Transducer (EMAT). The method utilises transducers that generate electromagnetic waves at the product's surface, which subsequently produce ultrasounds. This ensures that ultrasonic waves are generated in the test material and eliminates the use of couplant.

### SUMMARY

The invention is defined in the independent claims. Further embodiments of the invention are defined in the dependent claims.

According to an embodiment, a method of additive manufacturing of an object using object material is provided. The method may include forming the object by processing some of the object material, and forming an object identifier by forming a pattern having at least one coded volume within an internal volume of the object, each of the at least one coded volume enclosing unprocessed object material.

According to an embodiment, an object manufactured using the method of additive manufacturing disclosed herein is provided.

According to an embodiment, a method of scanning an object identifier formed using the method of additive manufacturing disclosed herein is provided. The method may include scanning the object identifier with a scanner and acquiring imaging information therefrom.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a flow chart illustrating a method of additive manufacturing of an object using object material, according to various embodiments.

FIG. 1B shows a method of scanning an object identifier, according to various embodiments.

FIG. 2 shows an example of an encoding scheme.

FIG. 3 shows schematic diagrams illustrating the design requirements for simple multi-level coding, according to various embodiments.

FIG. 4A shows an example of a block having simple multi-level coding, according to various embodiments.

FIG. 4B shows examples of designs with various multi-level codes and the corresponding ultrasonic scanned images, according to various embodiments.

FIG. 4C shows a photograph of a batch of 23 printed blocks with various simple multi-level codes, according to various embodiments.

FIG. 5A shows an example of a block having linear bit coding, according to various embodiments.

FIG. 5B shows examples of designs with various code designs and the corresponding ultrasonic scanned images, according to various embodiments.

FIG. 6A shows linear bit coding sequence, according to various embodiments.

FIG. 6B shows multi-depth coding sequence, according to various embodiments.

FIG. 6C shows a scheme of multi-depth void and metal differences, according to various embodiments.

FIG. 6D shows a bit depth coding method, according to various embodiments.

FIG. 7 shows examples of designs of various objects with codes and the corresponding ultrasonic scanned images, according to various embodiments.

FIGS. 8A to 8C show images of a measurement setup, according to various embodiments.

FIG. 9 shows a process flow for 3D printed EIMs (Embedded Identifier Modules).

FIGS. 10A and 10B respectively show the CAD model and the scanned model comparison for design 1 of Example 1.

FIGS. 10C and 10D respectively show the CAD model and the scanned model comparison for design B23 of Example 2.

FIG. 10E shows an image of an object (EIM) that has been sectioned to show the void designs, while FIG. 10F shows a microscopy image (10× zoom) of a void of the object of FIG. 10E.

FIG. 10G show images of a printed bevel gear in various views, while FIG. 10H show images of a printed hip implant in various views.

FIGS. 10I and 10J respectively show a bolt embedded with an identification code and the corresponding scanned image of the code.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the term “about” or “approximately” as applied to a numeric value encompasses the exact value and a reasonable variance. As used herein, the term “and/or” includes any and all combinations of one or more of the associated listed items. As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may relate to embedded identifier module (EIM).

Various embodiments may enable identifiers to be embedded into parts, for example, (3D) printed parts (e.g., metal 3D printed parts), for tracking and traceability purposes. The technologies disclosed herein may enable users to track the origin of the parts including, for example, the production line, the production date and even the source of the powder (or ingredient) depending on which information is required to be embedded into the system or objects. As the codes or identifiers are embedded inside the (printed) objects or parts, approaches based on optical reading, e.g., light-based like serial bar, QR (quick response) code, or touch-based, are not possible. RFID (radio-frequency identification) is also not possible where the objects are made of metal, which prevents penetration of electromagnetic field from the reading devices. For the technologies disclosed herein, detection technologies such as ultrasonic scan and CT (computed tomography) scan may be used. However, due to the need to scan the parts relatively quickly and/or to keep the cost low, ultrasonic scanning is preferable.

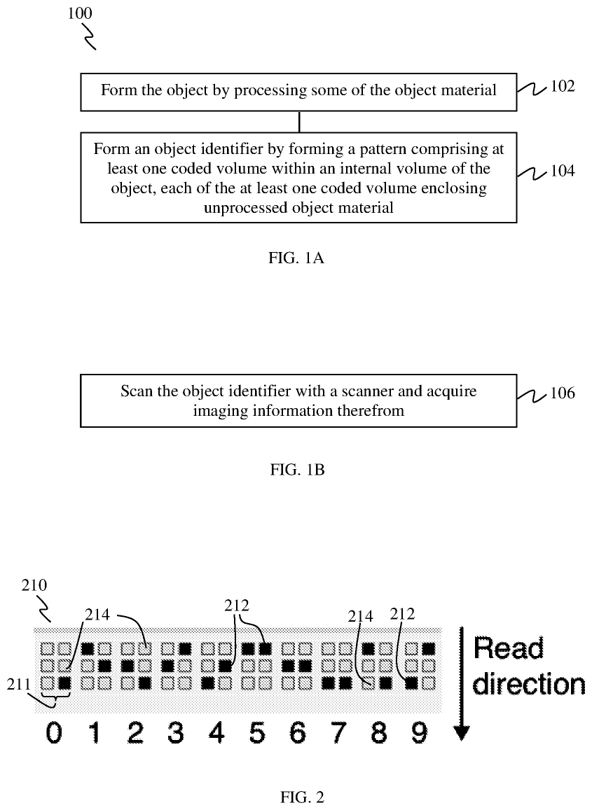

FIG. 1A shows a flow chart 100 illustrating a method of additive manufacturing of an object using object material, according to various embodiments. At 102, the object is formed by processing some of the object material. At 104, an object identifier is formed by forming a pattern having at least one coded volume within an internal volume of the object, each of the at least one coded volume enclosing unprocessed object material.

In other words, the object is formed of or from object material that is processed while each of the at least one coded volume includes the same object material but that is unprocessed. As such, an identifier may be formed using only the principal object material used in the making of the object thereby obviating the need for the use of a second material, or to add an additional processing step to process the object material forming the identifier differently from the object material forming the remainder (the body) of the object. Numerous different patterns and encoding techniques may be used.

In the context of various embodiments, a coded volume enclosing unprocessed object material may be defined as a “void”.

In the context of various embodiments, the term “internal volume” may refer to the interior or inside of the object.

In various embodiments, the at least one coded volume may be formed entirely within the object. This may mean that the at least one coded volume may not be exposed.

In various embodiments, the pattern may be formed by forming a first coded volume at a first location in the internal volume of the object, the first coded volume being disposed relative to a reference location, the location of the first coded volume relative to the reference location being representative of a character associated with (or encoded by) the pattern.

In various embodiments, the pattern may be formed by forming further coded volumes at further locations in the internal volume of the object, the location of the further coded volumes relative to the reference location being representative of the character associated with (or encoded by) the pattern.

For instance, if, in the coding scheme, coded volumes can be formed at multiple predetermined locations relative to the reference location, forming coded volumes at one or more of the predetermined locations can be used to represent a character associated with the pattern. For instance, if the pattern is used to form a linear bit sequence, say a series having an N-bit word, where coded volumes can be formed at any or all of N positions spaced or disposed relative to the reference location (where each of the N positions represents one bit in the N-bit word), then a total of (2 to the power N)−1 (i.e., 2^{N}−1) different patterns can be encoded by forming coded volumes at any or all of the N positions. Higher ordering coding sequences can be implemented using multiple N-bit words, or simply using higher values for the number N. Detection techniques—such as using ultrasound scanners—to scan the object/object identifier and, therefrom, identify distances of coded volumes from the reference point thereby to derive a character encoded by the pattern.

In various embodiments, the reference location may be a reference coded volume disposed within the internal volume of the object. For instance, the reference coded volume may be a “start flag” or “guard tag” formed using the same method or technique to form the other coded volumes, and where the reference coded volume indicates that any coded volume detected at one of the following N-bit locations spaced from the reference location form part of the pattern.

In various embodiments, the reference location may be on an external surface of the object. Alternatively (or perhaps additionally), a distance that the coded volume is from an external surface of the object may be representative of the character associated with the pattern. For example, the external surface may be a scanning surface against which a reader—such as an ultrasound scanner—may be placed in order to detect the coded volumes.

In various embodiments, the coded volumes may be formed to form a multi-dimensional array. So, for example, instead of, say, a linear bit sequence as mentioned above, a two-dimensional array or matrix of locations for coded volumes to be positioned can be used. In one example, the array may be two-dimensional in, say, a 3×2 matrix of coded volumes in a pattern, allowing at least 22 different characters to be encoded using such a matrix, the different characters being represented by different ways of populating the six positions in the 3×2 matrix with coded volumes. Multiple patterns, one for each character in the character string, can be arranged in a pattern recognisable by a reader, used in conjunction with suitable processing techniques.

Coming back to the situation where the pattern is a linear bit sequence, multiple N-bit strings can be formed in the array, where each of the N-bit strings may represent one character, and the array of patterns may define characters in a character string.

In various embodiments, the method may include forming a pattern defining a start character. As such, as an alternative (or perhaps even in addition) to forming a reference location, it is possible to designate a pattern in the array of patterns as a “start character”. Such a start character, when detected by a reader, denotes that pattern as being the start of a character string, and any patterns which are detected thereafter—for example, following the start character, such as being disposed in a reading order, say from left to right—represent characters in the character string.

In various embodiments, the pattern may be formed to define a “stop character”, the stop character indicating that the previous character was the last character in the character string. It should be appreciated that the method may form a character string having at least one of a start character or a stop character.

In various embodiments, the method may include forming a pattern, the pattern having a guard encoded volume for each character. It may be preferred that start and stop bits are not used. Alternatively (or even additionally), a vertical ‘guard’ void of, say, 0.5 mm in width may be inserted before each character. There may also be a space of, say, 0.5 mm between the guard and either character.

In various embodiments, the coded volumes may be formed in a three-dimensional matrix. Thus, forming the coded volumes at different depths within the internal volume of the object can add a further layer of complexity to the encoding scheme. In one example, the array may be a 3×2×2 matrix.

In various embodiments, the coded volumes may be arranged in a pattern or arrangement representative of plural characters, the method comprising forming a pattern of coded volumes for each of the plural characters. So, and using the example of the 3×2 matrix, one 3×2 array can be used to encode one character, and further 3×2 matrices can be used to encode further characters, the plural characters taken together forming a string of characters. In respect of the linear bit sequence technique for forming the object identifier, plural N-bit words may be used to encode plural characters to form the character string.

In various embodiments, the method may include forming an object identifier which may encode a character based on at least one of a dimension or a volume of the coded volume.

In various embodiments, the method may include forming an object identifier which may include a character based on a shape of the coded volume.

The additive manufacturing method may include or may be a selective laser sintering technique, and the object material may include or may be powder. The object material may include or may be polymeric powder.

The additive manufacturing technique may include or may be a selective laser melting technique, and the object material may include or may be a metallic powder.

In various embodiments, the additive manufacturing technique may include or may be a stereolithographic manufacturing process, and the object material may include or may be polymeric liquid, and the method may include forming coded volumes that enclose unprocessed polymeric liquid.

In various embodiments, the additive manufacturing technique may include or may be multi jet fusion manufacturing process, and the object material may include or may be powder.

In various embodiments, the processed object material may have a first density and the unprocessed object material may have a second density, the first density being different from the second density. Different densities may affect the speed of sound through the corresponding materials.

In various embodiments, each of the coded volumes may have internal surfaces, each of the internal surfaces being disposed at least a minimum distance from an external scanning surface of the object. As non-limiting examples, the minimum distance may be between about 2 mm and about 10 mm, for example, approximately one of 2 mm, 3 mm, 4 mm, 5 mm, 6 mm, 7 mm, 8 mm, 9 mm and 10 mm.

In various embodiments, each of the coded volumes may have internal surfaces that are roughened.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

Various embodiments may further provide an object that is manufactured using the additive manufacturing method disclosed herein (e.g., the method as described in the context of the flow chart 100). This may mean that the object may include object material that has been processed (i.e., processed object material) and an object identifier including a pattern having at least one coded volume within an internal volume of the object, each of the at least one coded volume enclosing unprocessed object material (i.e., the same object material but that has not been processed).

FIG. 1B shows a method of scanning an object identifier, according to various embodiments. The object identifier is formed using the method disclosed herein (e.g., the method as described in the context of the flow chart 100). At 106, the object identifier is scanned with a scanner and imaging information is acquired therefrom. For example, the object identifier may be scanned to obtain one or more scanned images of the object identifier. Information associated with or encoded by the object identifier may be obtained or recovered using the scanned image(s).

In various embodiments, the scanner may include or may be an ultrasonic scanner, for example, an Electromagnetic Acoustic Transducer (EMAT).

In various embodiments, the scanner may include or may be a CT scanner.

In various embodiments, the scanner may include or may be an X-ray scanner (or an X-ray scanning apparatus). For example, the object with an object identifier may be a medical implant. When implanted in a patient, X-ray scanning technique may be used to obtain or scan the object identifier or the implant information.

The technologies disclosed herein may be capable of enabling a closed loop of several processes: 1) encoding required (or defined) messages into identifiers, which subsequently are incorporated in the designs of items or objects (e.g., 3D printed items), 2) embedding the identifiers into the objects (e.g., 3D printed items), and 3) subsequent extraction of encoded messages using scanning apparatuses (e.g., ultrasonic scanning devices). This may allow a unique identifier of any item/object to be generated and/or embedded at the production time with little to zero additional cost. The unique identifier can be read off from the object later, for example, to verify its authenticity. Since the identifiers may not be extracted easily, unauthorized production of protected merchandise or objects can be prevented by verifying its identifier.

Various embodiments may have one or more of the following features:

(i) Identifiers are made of the same material as the base material: The base material used to fabricate an object is processed (object) material, e.g., material processed by 3D printing technology. Each of the identifiers, however, may include or consist of a volume or region filled with unprocessed (object) material. The contrast between sound velocities in the unprocessed and processed materials may sufficiently allow ultrasound detection methods to locate and identify at least one of position, size, or shape of such volumes of unprocessed material. The identifiers may be fabricated at the same time as the object, and, therefore, no additional process steps may be necessary to enable the working principle of the identifiers. The density of the packing may be specific to the selected 3D printing process. However, this is not critical, as long as it is suitable for the 3D printing process.

(ii) The ultrasound detection may allow detection with or without the use of a couplant between an object's surface and an ultrasound probe. Various embodiments may not require a couplant, which may be possible with the use of an Electromagnetic Acoustic Transducer (EMAT), which may allow non-contact sound generation and reception using electromagnetic waves. If a couplant is not required, it would be much easier to implement the methods. However, it may be that each technique has its own strengths and benefits. The advantage of the embodiment without use of a couplant is convenience. However, there may be challenges in that readings may be susceptible to higher levels of induced noise.

(iii) Ultrasound detection may allow detection of unprocessed material volumes at multiple depths. This may allow construction of coding schemes that may include or consist of multi-level bit, thus allowing complex information to be encoded in identifiers. Such a three-dimensional (3D) coding scheme differs from the 2D counterpart and has great potential of encoding information of much higher density.

(iv) The shapes and/or depths of unprocessed material volumes can be designed to minimise unwanted reflection of ultrasound from an object's surface(s). Such reflection may generate artificial features on the scanned images, which may cause inaccurate extraction of the encoded information. In some arrangements, it is preferred that the shape of the encoded volume is round, for example, a spherical shape.

(v) Special unprocessed material volumes can be designed to absorb or diffuse ultrasound reflection to minimise or eliminate artificial features in scanned images. Since spurious features can appear in scanned images as the results of interferences or standing waves of signals reflected from the objects's surfaces, it is possible to design volumes with certain or special shapes and/or positions to act as a shield for the identifier(s) from unwanted signals. Unprocessed volumes having rough (for example, saw-tooth like) surfaces may be used to minimise or avoid standing waves from forming as artificial features in the scanned images may be caused by standing waves.

Various embodiments may allow embedding of identifiers that are both generated at the time of production and irremovable, in contrast to known approaches. Known methods that offer attachment or fabrication of identifiers on the surface of produced items are still prone to removal or imitation. As the identifiers produced using the technology disclosed herein are embedded within the produced objects/items, it may be difficult to imitate both the item and the embedded identifier. One of the very few ways allowing counterfeit items to be produced is a complete reverse engineering process of the item, starting from internal structure scanning using CT scanners, which is cost prohibitive for counterfeit attempts. Further, the embedding method of identifiers of various embodiments adds very little cost to the process (e.g., 3D printing process) where additional cost may be (only) due to designing of the identifier. The method of various embodiments may also not require any insertion of new material into the (printed) object, making it flexible for implementation.

By way of non-limiting examples, the technologies disclosed herein or the various embodiments will be described in terms of (3D) printed objects, including, for example, 3D printed metal objects/parts. Further, while various examples described below may employ the use of ultrasonic for measurement or scanning purposes, it should be appreciated that terahertz (THz), X-ray, ultraviolet (UV), visible light, or any other wave-based scanning technique may be used.

Various embodiments may enable embedding identifiers into 3D printed objects, for example, for tracking and determination of the objects' traceability. The traceability parameters of a 3D printed object may include various information such as one or more of its origin, production line and methods, production date, and source of the material. The methods of encoding information into identifiers, embedding identifiers into 3D printed objects, and subsequently recovering encoded information from the 3D printed objects by ultrasonic scanning apparatuses are described below.

An identifier of a 3D printed object may be created at the time the object is produced using a 3D printing technology. The item is made of a certain (object) material, which is processed using the 3D printing technology. Each identifier is a pattern or arrangement of volumes having unprocessed material inside the printed object. Each of these volumes is referred herein as a “coded volume”. The difference between the unprocessed object material in coded volumes and the processed object material is that the unprocessed material may contain a much higher air content, thus, resulting in a much lower sound speed compared to the processed material: the higher the gas/air content, the more impeded the sound wave, and the lower the sound speed. The geometrical dimensions and/or relative positions of these volumes are parameters that may be used to encode information using a defined encoding scheme. The choice of encoding scheme depends on various factors such as one or more of: complexity and/or length of the encoded messages, the space available for embedding the identifier within the printed object, and the technology used to read or extract the encoded information from the object.

One or more parameters may be varied to accommodate various encoding schemes, depending on the complexity of the messages to be encoded. These parameters may include positions, shapes, and sizes of the unprocessed material volumes, i.e., the coded volumes. For simple encoding schemes, it may be sufficient to vary one of these parameters, while for complex encoding schemes, one or more or all of the parameters may be used at the same time.

Once the object has been printed with the embedded identifier, a scanning apparatus such as an ultrasonic scanning apparatues (e.g., a phased array ultrasonic apparatus) may be used to image at least one of the sizes, shapes, or positions of the coded volumes. This may be possible due to the contrasted sound speeds in the unprocessed and processed materials. Other ultrasonic scanning apparatuses may also be used, including monolithic probes. This type of probes requires sweeping the detecting probe across the surface of the object embedded with the identifier. The phase array probes may require an ultrasonic couplant between the probe and the object's surface. The use of the couplant may be eliminated by using electromagnetic acoustic transducers (EMAT) instead of piezoelectric transducers in the phased array.

It should be appreciated that there are various choices for ultrasonic apparatus to image the unprocessed material volumes. In situations where cost may be a consideration in implementing the technologies disclosed herein, a single monolithic probe can be used to sweep across the surface of the object. The received signal may be processed to detect the sizes and/or positions of the unprocessed material volumes.

One or more images resulting from the ultrasonic scanning may then be used to extract the geometrical configuration of the encoded volumes of the identifier. By using the encoding scheme, the extracted geometrical configuration can be translated to recover the encoded information, which is initially intended to accompany the object.

As a non-limiting example, the technologies disclosed herein may be adapted into the following workflow:

Selection of the encoding scheme: A defined encoding scheme may be employed to establish a correlation between basic geometrical configurations of the encoded volumes and units of information. The complexity of the information to be encoded and the available space in the 3D printed information may be used to determine the encoding scheme's characteristics. For example, a scheme to encode a series of numbers from 0 to 9 may only require 10 different uniquely defined geometrical configurations for the encoded volumes, while a scheme to encode messages of text and numbers is likely to require a much higher number of different configurations. An example of a scheme 210 used to encode messages having or consisting of only numbers are shown in FIG. 2. As may be observed, a pattern (represented by 211 as illustrated for the number “0”) may be defined for each of the numbers from 0 to 9. Each illustrated dark area represents a coded volume or encoded volume (as presented by 212 for three dark areas), which may either be empty, unsinterred, or unmelted. Therefore, each dark area may represent unprocessed object material. Each illustrated light area (as presented by 214 for three light areas) represents a volume of processed object material, i.e., the base material of the object.

Designing and incorporating the identifier with encoded information: The message to be encoded into a printed object may be translated to the geometrical configuration of the encoded volumes of the identifier. The design of the identifier may then be incorporated into the object at the designated location. The requirement(s) for the identifier's location may include space availability of the printed object, and/or the accessibility of probing signals of the scanning apparatuses.

Scanning/reading of the embedded identifier: The combined design of the object and the incorporated identifier can be used to print the object embedded with a physical identifier. An ultrasonic scanning apparatus can be used to scan and image the internal structure or interior of the printed object in the vicinity of the identifier. The scanning probe of the ultrasonic scanning apparatus may make contact with the printed object at a designated surface area for the imaging process and may require application of a couplant.

Decoding the embedded identifier: The scanned image of the identifier is used for further image processing to identify the geometrical configuration of the encoded volumes. The detected geometrical configuration may then be translated to the original message intended to accompany the printed object.

For the fabrication of metal specimens or objects, the additive manufacturing (AM) process used may be selective laser melting (SLM). This process works by selectively melting metal powders layer by layer to form the final object. As a non-limiting example, the AM equipment used for fabricating of the objects may be a SLM500HL printer manufactured by SLM Solutions.

In order to encode identifiers into metal parts, the techniques disclosed herein build or incorporate voids into the 3D printed object as an inclusion of the design. The location of the voids is such that the voids do not affect structural components and are relatively close to the surface of the object to allow detection via ultrasound. It is preferable to employ ultrasound as the means of detection due to its fast speed of detection and low cost, compared to CT Scan, which is slower and more expensive, although it is also possible to use CT scan in various embodiments. One example of material choice is Stainless Steel 316L (SS316L) as the printability of this material is well established and also the material cost is relatively cheaper compared to other materials.

The identifier code may include or may be defined by “voids”, which may be un-sintered (or unprocessed) SS316L powder trapped within an enclosed space. Each void is a coded volume. The void sizes may range from about 1 mm² to about 4 mm² with a depth of about 5 mm. The voids are usually in the form of a cuboid for easy identification, although other shapes are also possible, for example, triangles and circles.

Alternatively, a stereolithographic manufacturing process may be used to form the coded volumes that enclose unprocessed polymeric liquid. As a further alternative, other additive manufacturing processes, operating on suitable materials, may be employed. To be able to read these voids that are embedded into the metal object or part, the ultrasonic scanner needs to be calibrated to the speed of sound of the metal object before the voids can be read, as speed of sound varies differently for each material due to density. For example, the density of aluminum is about 2700 kg/m³ while that of a SS316L is about 8250 kg/m³. This difference itself may cause noise in the scan and the voids may be blocked out by feedback noises.

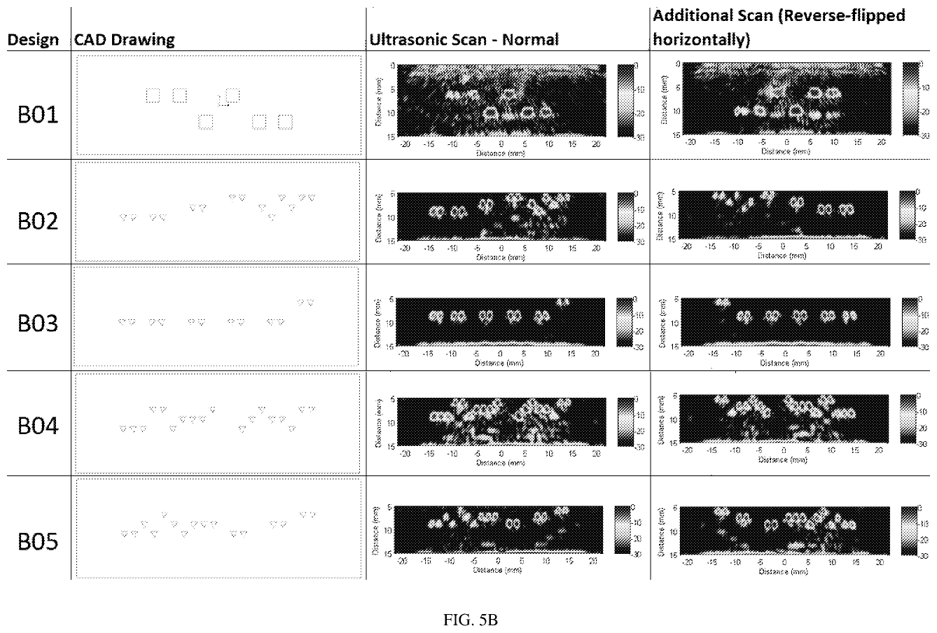

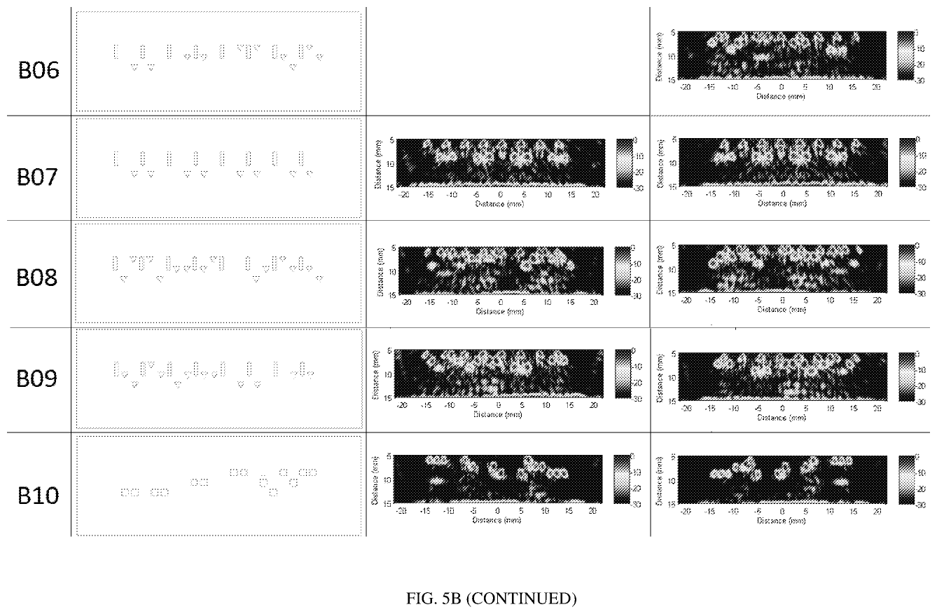

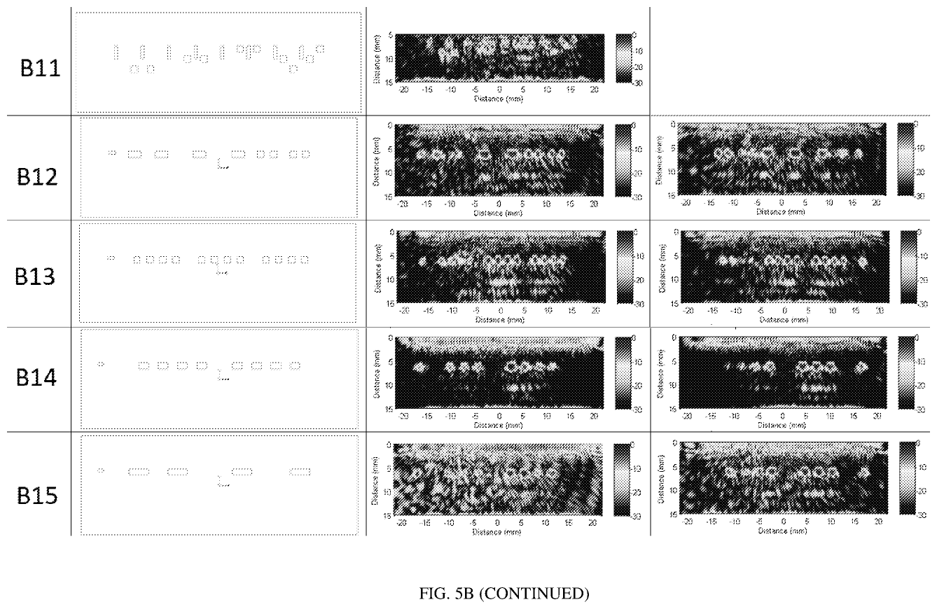

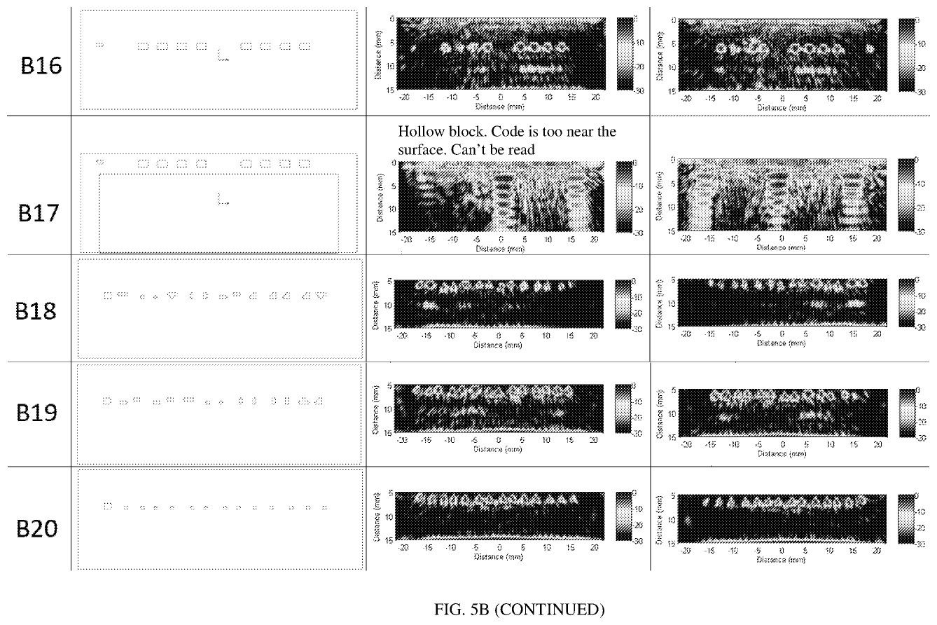

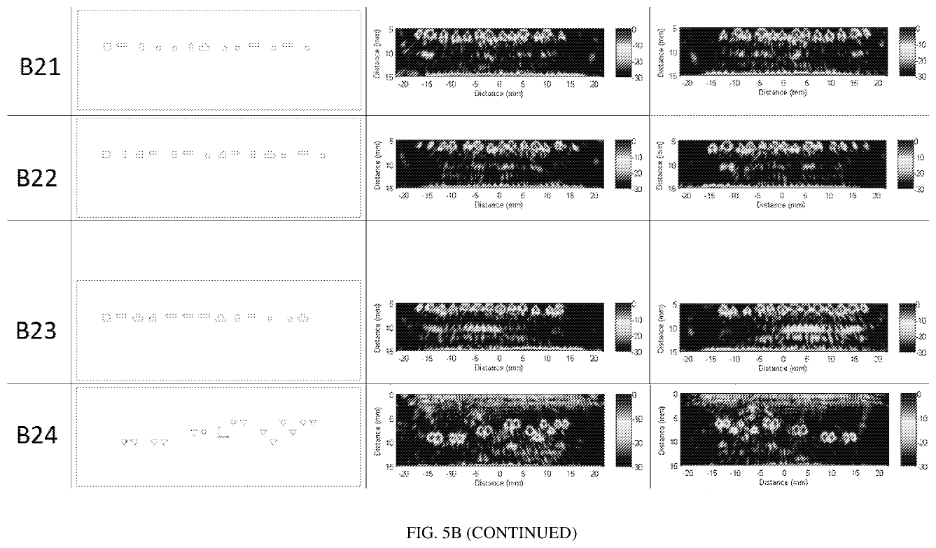

In various embodiments, the identifiers are encoded according to the selected type of coding scheme. In a first example (Example 1), a first set of codes used is known as multi-level codes, which include voids embedded in a 3D space that has one or more features such as different heights from a reference plane, varying distance between neighboring voids, and different void geometries. In a second example (Example 2), other coding methods and an extension of the multi-level code may be used. Examples of such other coding schemes include linear bit codes, which include 2 different sizes and configurations, and bit depth encoding (BLD), which is a set of 6 codes arranged in a 2×3 format (see FIG. 5B to be described further below). Identifiers defined using any one of the coding schemes may then be implemented into real life products, as will be described further below (refer to Example 3).

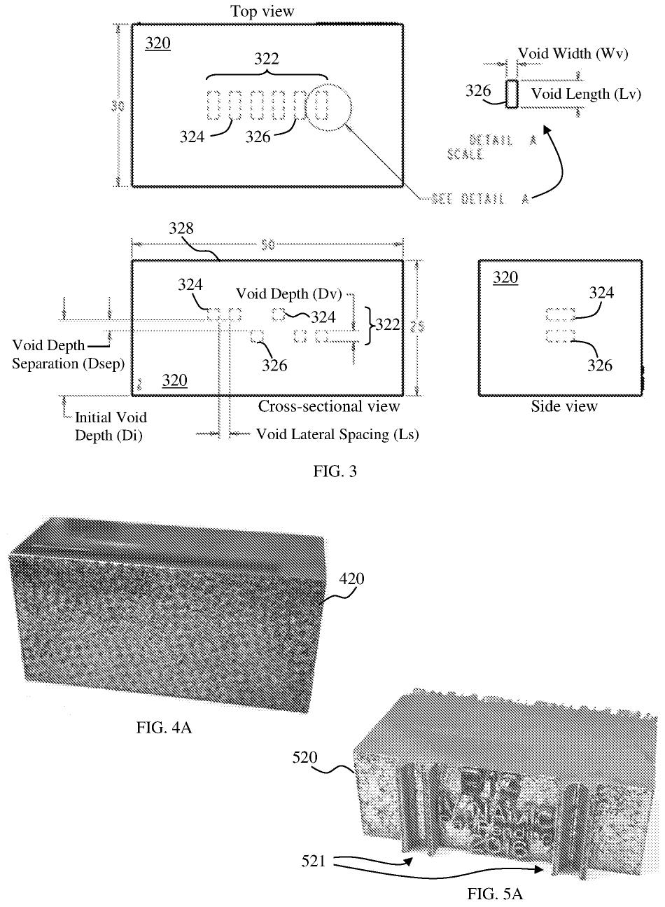

For Example 1, rectangular blocks of approximately 50 mm×30 mm×25 mm (Length (L)×Breadth (B)×Height (H)) may be printed/used for introduction and demonstration of simple multi-level coding. FIG. 3 shows schematic diagrams illustrating the design requirements for simple multi-level coding, according to various embodiments. A non-limiting example of a rectangular block 320 with a pattern or arrangement 322 of voids 324, 326 are shown in FIG. 3. The voids 324, 326 may be arranged relative to each other along corresponding axes or planes in the height direction of the block 320. For example, the voids 324 are arranged above or over the voids 326. It should be appreciated that the rectangular block 320 is described as an example and that other shapes, including corresponding to real-life objects, may be printed.

Various designs with the corresponding codes based on simple multi-level coding may be provided for Example 1. In the various designs, the void pattern or arrangement (e.g., 322) may be centred within the block plan view (i.e., view looking down onto the top surface of the block) of the block (e.g., 320). In the various designs, voids that are closest to the read or scanning surface may be designated as “H” bits or voids, while voids that are farther away may be designated as “L” bits or voids. An arrangement of voids (e.g., 322) may generally or always starts with a “H” void and ends with an “L” void. Using the example of FIG. 3, and, assuming, for illustration purposes, that a scanning apparatus or probe is positioned proximal to the surface 328 of the block 320 for scanning, the voids 324 are “H” voids and the voids 326 are “L” voids.

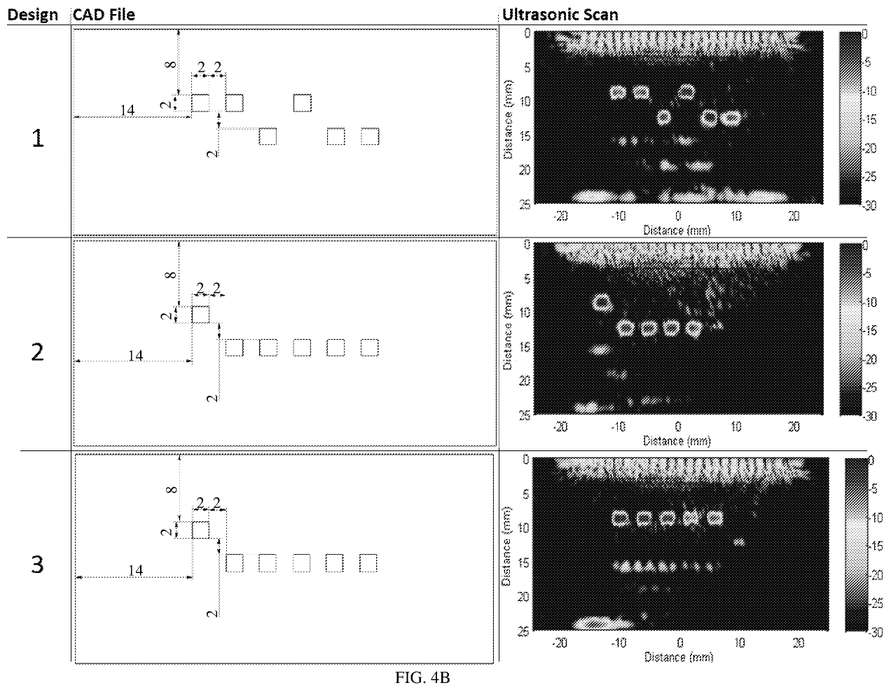

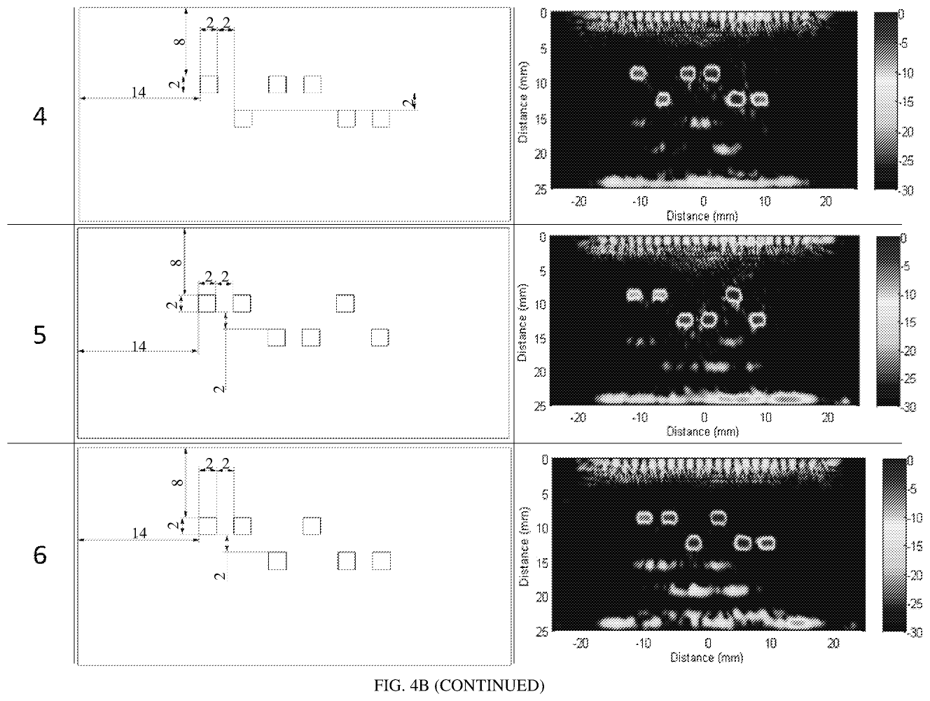

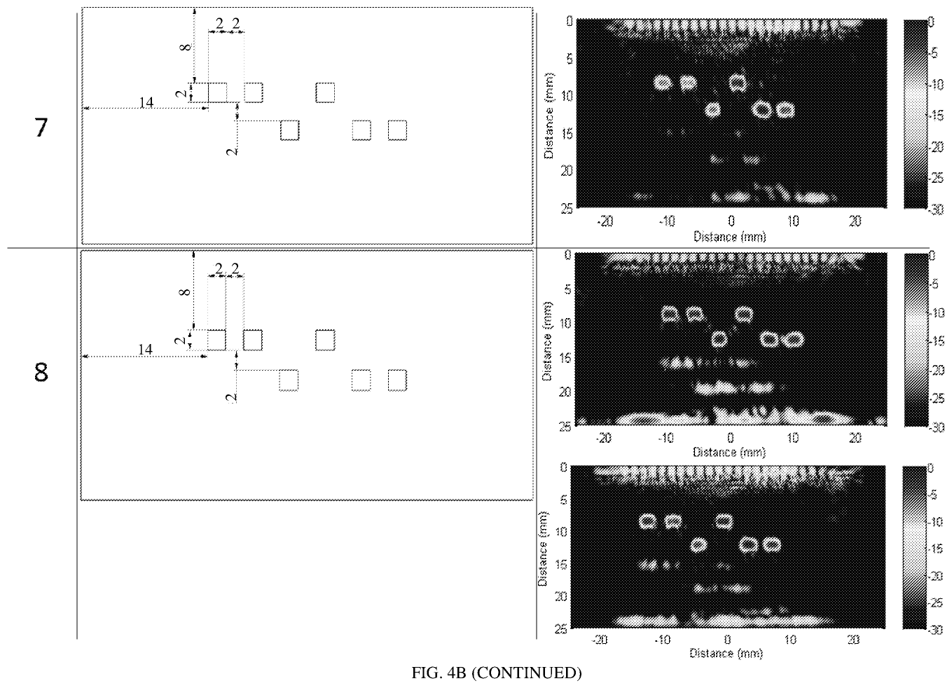

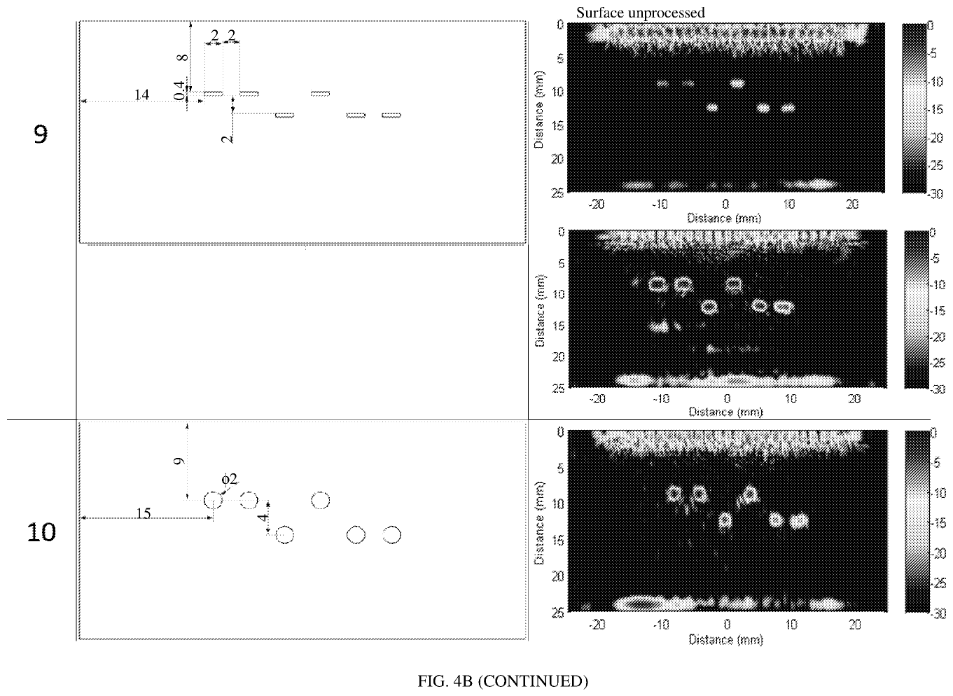

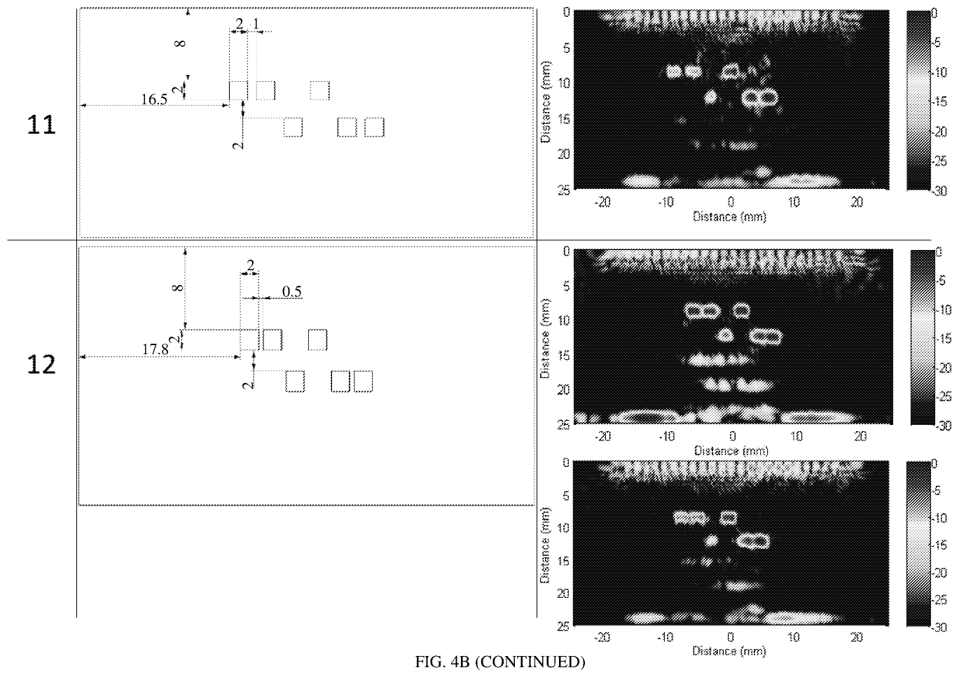

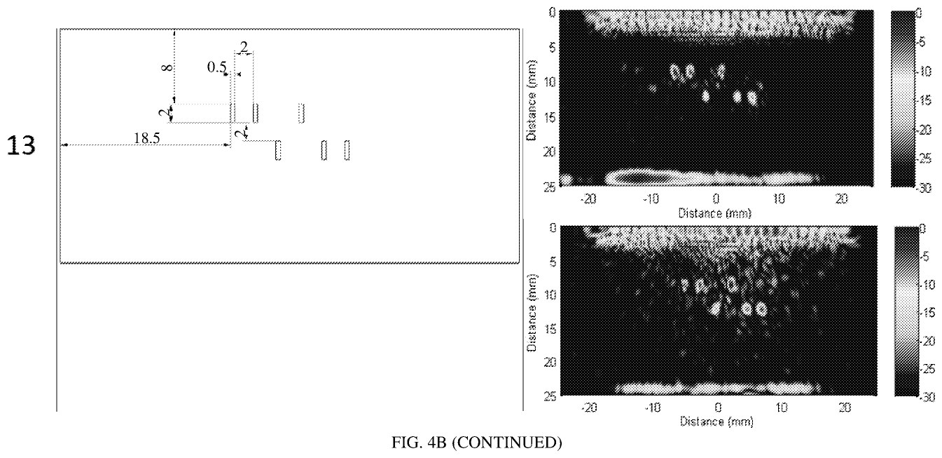

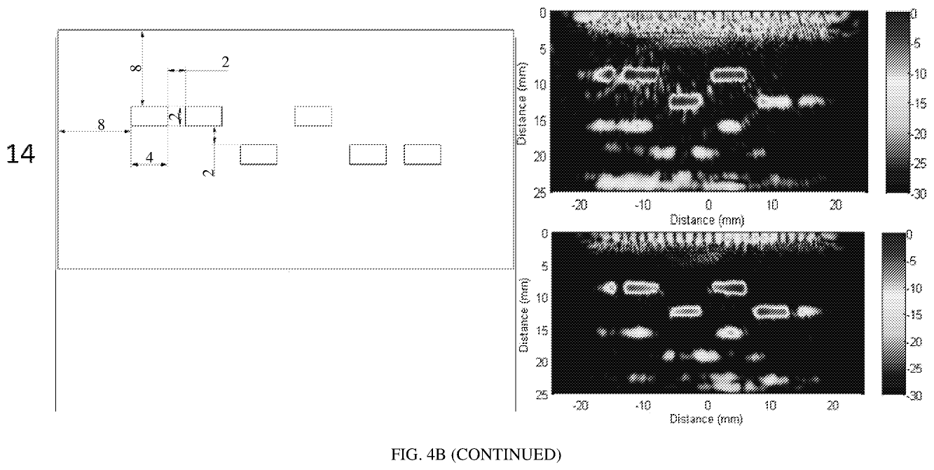

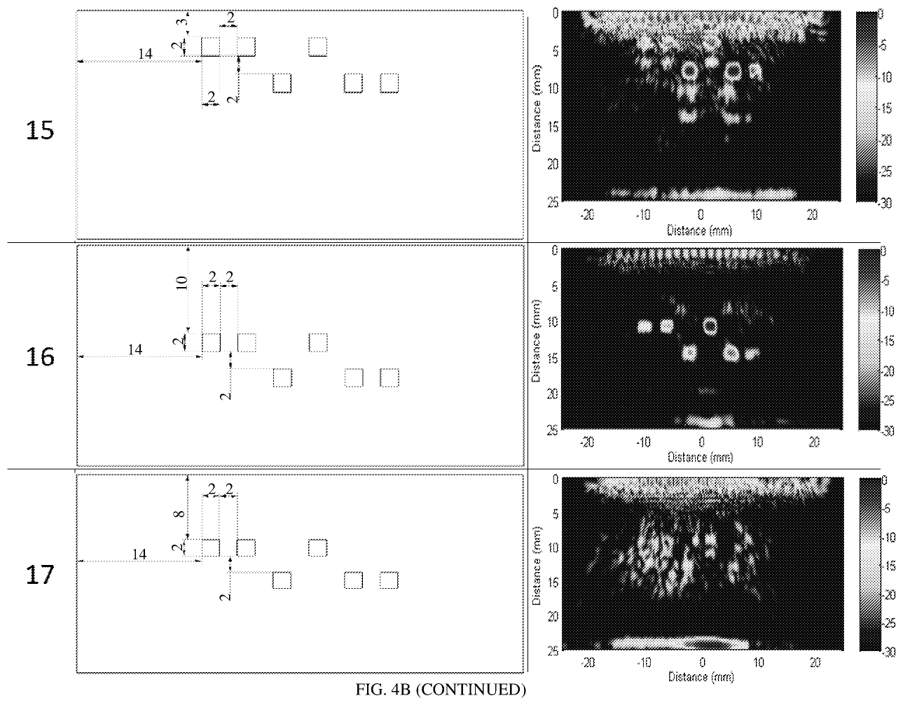

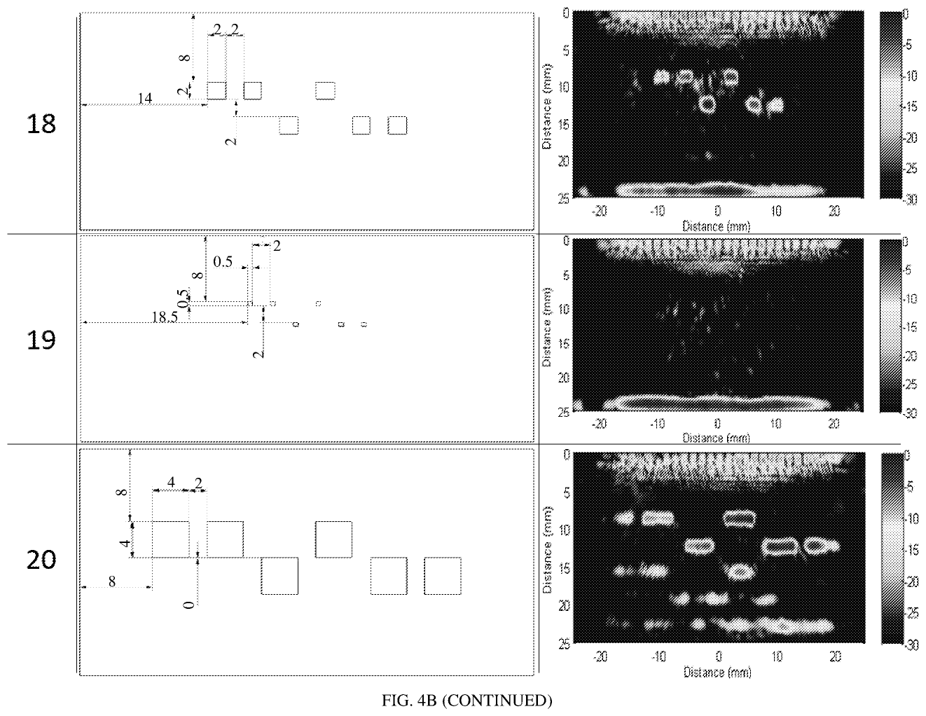

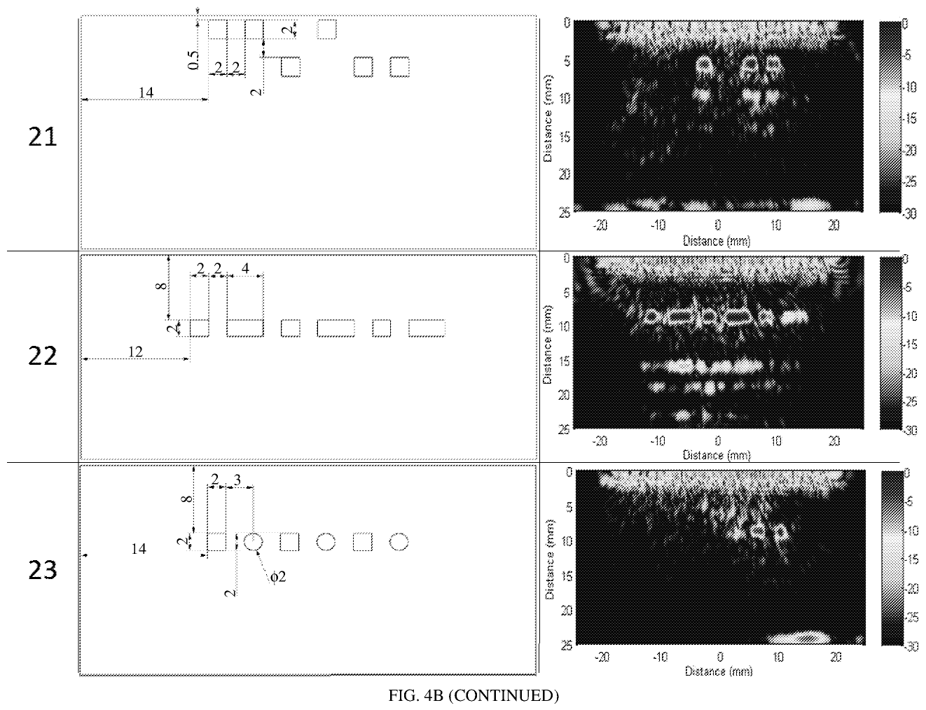

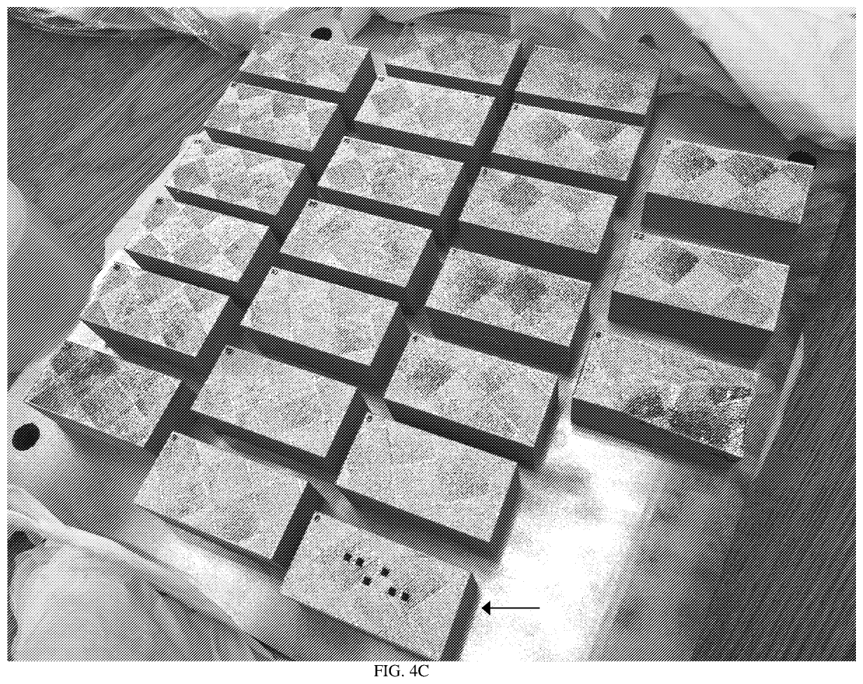

For Example 1, a block 420 may be printed with simple multi-level coding, which for the example shown in FIG. 4A corresponds to design 8 (refer to TABLE 1 and FIG. 4B). A total of 23 different sets of information based on multi-level coding may be provided or designed. A batch of 23 blocks may be printed, each block having a different respective code. Each code is approximately 2 mm×2 mm×5 mm in overall size, and may have 2 levels; high and low, meaning that there may be H void(s) and L void(s).

TABLE 1 and FIG. 4B show examples of 23 blocks designed with the corresponding codes based on simple multi-level coding for Example 1. FIG. 4B further shows the ultrasonic scanned images corresponding to the different designs. An example of the scanning process will be described further below. Also, FIG. 4C shows a photograph of a batch of 23 printed blocks with various simple multi-level codes for Example 1. For illustration purpose, the printed block with design 6 (indicated by arrow in FIG. 4C) is shown with the code exposed and in the form of through-holes (without any filling therein).

It should be appreciated that other shapes, including corresponding to real-life objects, may be printed with various codes based on the simple multi-level coding.

Referring to TABLE 1, the parameters “Wv” and “Dv” are the width and aspect ratio of the voids respectively, in mm and ratioed to the width value. As an example using Design 9, “5:1 rectangular” for Dv means that the depth is 5× the width. The column “Fill” provides information on whether the codes are voids with filling or through-holes without filling therein. The “Full Pattern (with sign)” column refers to the encoded information (from the “Pattern” column’) with additional beginning and end markers (e.g., “Start” and “Stop” characters), which may act as basis for calculation of the overall length. For Design 22, the encoding is on the basis of width, and not depth, where, as shown in the “Notes” column, a 2 mm width corresponds to the “L” bit and 5 mm to the “H” bit. For Design 23, the encoding pattern is complex and uses different shapes, where a square represents the “L” bit and a circle represents the “H” bit.

For Example 2, various designs with the corresponding codes may be provided by means of thinner rectangular blocks, e.g., of approximately 42 mm×22 mm×15 mm, and with optional mounting holes. The mounting holes may be optionally designed and provided for the purpose of alignment of the (ultrasonic) scanning probe to make the scanning process easier. The block design may be similar to block 520 with the relevant coding, which for the example shown in FIG. 5A corresponds to design B13 with linear bit coding (refer to TABLE 2 and FIG. 5B) and having mounting holes 521.

For Example 2, three code designs, namely, multi-level with 2 variations, linear bit coding, and bit depth encoding (BLD) are introduced. The multi-level coding is improved by introducing one or more of more variations of the codes, longer code length for UPC coding, and shrunk up to 50 percent in size compared to those for Example 1.

A total of 24 blocks were printed for Example 2 with the relevant codes provided in TABLE 2 and FIG. 5B. The ultrasonic scanned images corresponding to the different code designs are also shown in FIG. 5B. An example of the scanning process will be described further below. The voids are designed to be smaller for printing of thinner objects or parts, and the thinner blocks were used as non-limiting examples to explore the effects of reflected noise. It should be appreciated that other shapes, including corresponding to real-life objects, may be printed with the various codes provided for Example 2.

TABLE 1
DESIGNS WITH SIMPLE MULTI-LEVEL CODES FOR EXAMPLE 1

| Design | Lv | Wv | Dv | Di | Ls | Dsep | | | Full Pattern | Total Pattern | |
|---|---|---|---|---|---|---|---|---|---|---|---|
| number | (mm) | (mm) | (mm) | (mm) | (mm) | (mm) | Fill | Pattern | (with sign) | Length | Notes |
| 1 | 5 | 2 | 1:1 Square | 8 | 2 | 2 | yes | HLHL | HHLHLL | 22 | Baseline Design |
| 2 | 5 | 2 | 1:1 Square | 8 | 2 | 2 | yes | LLLL | HLLLLL | 22 | BD Pattern Test |
| 3 | 5 | 2 | 1:1 Square | 8 | 2 | 2 | yes | HHHH | HHHHHL | 22 | BD Pattern Test |
| 4 | 5 | 2 | 1:1 Square | 8 | 2 | 2 | yes | LHHL | HLHHLL | 22 | BD Pattern Test |
| 5 | 5 | 2 | 1:1 Square | 8 | 2 | 2 | yes | HLLH | HHLLHL | 22 | BD Pattern Test |
| 6 | 5 | 2 | 1:1 Square | 8 | 2 | 2 | No | HLHL | HHLHLL | 22 | BD, no fill |
| 7 | 5 | 2 | 1:1 Square | 8 | 2 | 2 | yes | HLHL | HHLHLL | 22 | BD replication |
| 8 | 5 | 2 | 1:1 Square | 8 | 2 | 2 | yes | HLHL | HHLHLL | 22 | BD replication |
| 9 | 5 | 2 | 5:1 Rectangular | 8 | 2 | 2 | yes | HLHL | HHLHLL | 22 | Aspect Ratio |
| 10 | 5 | 2 | 1:1 Circular | 8 | 2 | 2 | yes | HLHL | HHLHLL | 22 | Aspect Ratio |
| 11 | 5 | 2 | 1:1 Square | 8 | 1 | 2 | yes | HLHL | HHLHLL | 17 | Spacing |
| 12 | 5 | 2 | 1:1 Square | 8 | 0.5 | 2 | yes | HLHL | HHLHLL | 14.5 | Spacing |
| 13 | 5 | 0.5 | 1:1 Square | 8 | 2 | 2 | yes | HLHL | HHLHLL | 13 | Width |
| 14 | 5 | 5 | 1:1 Square | 8 | 2 | 2 | yes | HLHL | HHLHLL | 40 | Width |
| 15 | 5 | 2 | 1:1 Square | 3 | 2 | 2 | yes | HLHL | HHLHLL | 22 | Initial Void Depth |
| 16 | 5 | 2 | 1:1 Square | 10 | 2 | 2 | yes | HLHL | HHLHLL | 22 | Initial Void Depth |
| 17 | 0.5 | 2 | 1:1 Square | 3 | 2 | 2 | yes | HLHL | HHLHLL | | Void length |
| 18 | 2 | 2 | 1:1 Square | 8 | 2 | 2 | yes | HLHL | HHLHLL | 22 | Void Length |
| 19 | 0.5 | 0.5 | 5:1 Rectangular | 8 | 0.5 | 1 | yes | HLHL | HHLHLL | 5.5 | Smallest Lv & Wv; |
| | | | | | | | | | | | Smallest possible |
| | | | | | | | | | | | (except for depth) |
| 20 | 5 | 5 | 1:1 Square | 8 | 2 | 5 | no | HLHL | HHLHLL | 40 | Largest Lv & Wv; |
| | | | | | | | | | | | Largest possible |
| | | | | | | | | | | | (except for depth) |
| 21 | 5 | 2 | 5:1 Rectangular | 1 | 2 | 2 | yes | HLHL | HHLHLL | 22 | 1 mm below surface; |
| 22 | 5 | * | 1:1 Square | 8 | 2 | 0 | yes | HLHL | HHLHLL | 31 | Basehne Design, width |
| | | | | | | | | | | | encoded (2-L, 5 = H) |
| 23 | 5 | 2 | * | 8 | 2 | 0 | yes | HLHL | HHLHLL | 22 | Baseline Design, shape |
| | | | | | | | | | | | encoded (Sq-L, |
| | | | | | | | | | | | Circ = H) |

* = See “Notes” column.

TABLE 2
DESIGNS WITH VARIOUS CODE DESIGNS FOR EXAMPLE 2

| Design | Lv | Wv | Dv | Di | Ls | Dsep | | | Full Pattern (with | Total Pattern | | Pattern |
|---|---|---|---|---|---|---|---|---|---|---|---|---|
| Number | (mm) | (mm) | (mm) | (mm) | (mm | (mm) | Fill | Pattern | control bits) | Length | Notes | Length |
| B01 | 5 | 1 | 1:1 Square | 5 | 2 | 2 | yes | HLHL | HHLHHL | 16 | Example 1 | 4 |
| | | | | | | | | | | | Baseline | |
| | | | | | | | | | | | Design | |
| | | | | | | | | | | | Control | |
| B02 | 5 | 1 | Triangular | 5 | 1 | n/a | yes | 12345678 | (Start)12345678(Stop) | 34 | Multi-Level, | 8 |
| | | | | | | | | | | | no guards | |
| B03 | 5 | 1 | Triangular | 5 | 1 | n/a | yes | 12121212 | (Start)12121212(Stop) | 34 | Multi-Level, | 8 |
| | | | | | | | | | | | no guards | |
| B04 | 5 | 1 | Triangular | 5 | 1 | n/a | yes | ZY0XW987 | (Start)ZY0XW987(Stop) | 34 | Multi-Level, | 8 |
| | | | | | | | | | | | no guards | |
| B05 | 5 | 1 | Triangular | 5 | 1 | n/a | yes | 78901234 | (Start)78901234(Stop) | 34 | Multi-Level, | 8 |
| | | | | | | | | | | | no guards | |
| B06 | 5 | 1 | Triangular | 5 | 1 | n/a | yes | 12345678 | 12345678 | 33 | Multi-Level, | 8 |
| | | | | | | | | | | | with guards | |
| B07 | 5 | 1 | Triangular | 5 | 1 | n/a | yes | 12121212 | 12121212 | 33 | Multi-Level, | 8 |
| | | | | | | | | | | | with guards | |
| B08 | 5 | 1 | Triangular | 5 | 1 | n/a | yes | ZY0XW987 | ZY0XW987 | 33 | Multi-Level, | 8 |
| | | | | | | | | | | | with guards | |
| B09 | 5 | 1 | Triangular | 5 | 1 | n/a | yes | 78901234 | 78901234 | 33 | Multi-Level, | 8 |
| | | | | | | | | | | | with guards | |
| B10 | 5 | 1 | Square | 5 | 1 | n/a | yes | 12345678 | (Start)12345678(Stop) | 34 | Multi-Level, | 8 |
| | | | | | | | | | | | no guards | |
| B11 | 5 | 1 | Square | 5 | 1 | n/a | yes | 12345678 | 12345678 | 33 | Multi-Level, | 8 |
| | | | | | | | | | | | with guards | |
| B12 | 5 | 1 | Linear Bit | 5 | 1 | n/a | yes | 11001100 | Add start bit only | 32 | Small Linear | 26 |
| | | | | | | | | 11000011 | | | bit | |
| | | | | | | | | 10100101 | | | | |
| B13 | 5 | 1 | Linear Bit | 5 | 1 | n/a | yes | 01010101 | Add start bit only | 32 | Small Linear | 26 |
| | | | | | | | | 01010101 | | | bit | |
| | | | | | | | | 01010101 | | | | |
| B14 | 5 | 1 | Linear Bit | 5 | 1 | n/a | yes | 0101010 | Add start bit only | 32 | Large Linear | 15 |
| | | | | | | | | 1010101 | | | Bit | |
| B15 | 5 | 1 | Linear Bit | 5 | 1 | n/a | yes | 11001100 | Add start bit only | 32 | Large Linear | 17 |
| | | | | | | | | 11000011 | | | Bit | |
| B16 | 5 | 1 | Linear Bit | 5 | 1 | n/a | yes | 01010101 | Add start bit only | 32 | Large Linear | 17 |
| | | | | | | | | 01010101 | | | Bit | |
| B17 | 5 | 1 | Linear Bit | 5 | 1 | n/a | yes | 01010101 | Add start bit only | 32 | Large Linear | 17 |
| | | | | | | | | 01010101 | | | bit, Hollow | |
| | | | | | | | | | | | Box, 3 mm | |
| | | | | | | | | | | | walls | |
| 818 | 5 | 1 | BLD | 5 | 1 | n/a | yes | 0123456789893 | Add start bit only | 33.5 | Bit-Depth | 13 |
| B19 | 5 | 1 | BLD | 5 | 1 | n/a | yes | 6767012454538 | Add start bit only | 33.5 | Bit-Depth | 13 |
| B20 | 5 | 1 | BLD | 5 | 1 | n/a | yes | 1122121222111 | Add start bit only | 33.5 | Bit-Depth | 13 |
| B21 | 5 | 1 | BLD | 5 | 1 | n/a | yes | 041143120101 | Add start bit only | 31 | Bit Depth (12- | 12 |
| | | | | | | | | | | | digit UPC | |
| | | | | | | | | | | | code for a | |
| | | | | | | | | | | | box of raisins) | |
| B22 | 5 | 1 | BLD | 5 | 1 | n/a | yes | 4974019753201 | Add start bit only | 33.5 | Bit-Depth (13- | 13 |
| | | | | | | | | | | | digit EAN | |
| | | | | | | | | | | | code for a | |
| | | | | | | | | | | | Sharp toner | |
| | | | | | | | | | | | cartridge) | |
| B23 | 5 | 1 | BLD | 5 | 1 | n/a | yes | 038000357213 | Add start bit only | 31 | Bit Depth (12- | 12 |
| | | | | | | | | | | | digit UPC | |
| | | | | | | | | | | | code for a | |
| | | | | | | | | | | | breakfast | |
| | | | | | | | | | | | bar), Hollow | |
| | | | | | | | | | | | Box | |
| B24 | 5 | 1 | Triangular | 5 | 1 | n/a | no | 12345678 | (Start)12345678(Stop) | 34 | B02, unfilled | 8 |

Linear Bit

Linear bit codes may include a series of 8-bit words, where each bit may, for example, include either a square void or not. There may be a start bit and about 2 mm space between each word. Up to 24 bits (16.7 million) patterns or arrangements may be encoded, and this may take only about 1 mm in depth.

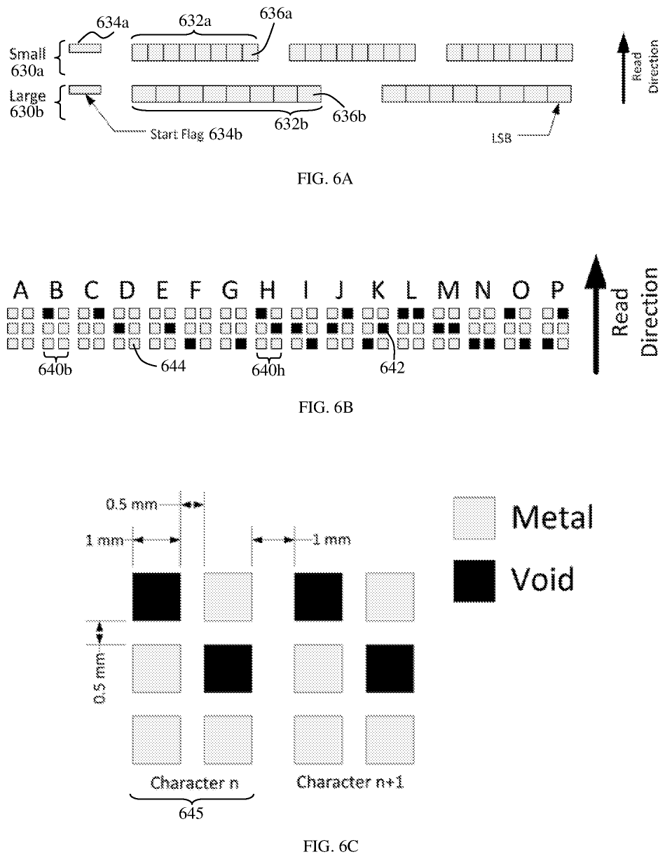

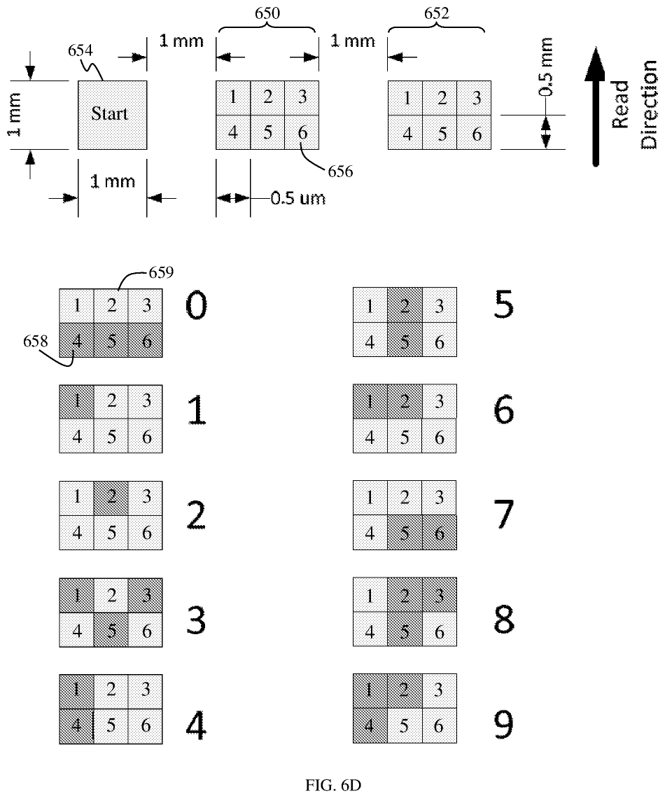

There may be 2 variations, for example defined as “Small” and “Large”. It may be challenging to distinguish bits in the “Small” scheme. FIG. 6A shows the linear bit coding sequence, illustrating the “Small” scheme 630a and the “Large” scheme 630b.

Each scheme may include one or more 8-bit words (represented as 632a for one 8-bit word for the “Small” scheme and 632b for one 8-bit word for the “Large” scheme). LSB (least significant bit) is on the right, in keeping with standard binary convention. Each scheme may further include a start flag 634a, 634b. The start flag 634a, 634b may be about 0.5 mm thick, biased below the read surface of the object.

The “Small” scheme may employ about 1 mm square voids (represented as 636a for one void) and about 2 mm between the words 632a, which may allow 24 bits, and the “Large” scheme may employ approximately 1.5 mm×1 mm rectangular voids (represented as 636b for one void) and about or up to 4 mm between gaps, for a 16-bit message. In other words, each allocated character string for a code (e.g., word 632b), depending on the code design, may be up to about 4 mm long.

Multi-Level

Each character may include or consist of 6 dots in a 2×3 pattern, e.g., pattern 640b corresponding to the character “B” and pattern 640h corresponding to the character “H” as illustrated in FIG. 6B showing multi-depth coding sequence. There may be 16 readable characters using such 2×3 patterns, which may have the corresponding meanings as shown in TABLE 3. The notations “W”, “X”, “Y” and “Z” in TABLE 3 are used to represent characters other than numbers, similar to hexadecimal notation. Each pattern may include one or more voids (or coded volumes) (as represented by dark areas, and represented by 642 for one such dark area) and/or one or more volumes of processed object (or base/metal) material (as represented by light areas, and represented by 644 for one such light area).

TABLE 3
CHARACTERS AND THEIR CORRESPONDING MEANINGS

| Pattern | Meaning |
|---|---|
| A | W |
| B | 1 |
| C | 2 |
| D | 3 |
| E | 4 |
| F | 5 |
| G | 6 |
| H | 7 |
| I | 8 |
| J | 9 |
| K | X |
| L | Start |
| M | 0 |
| N | Stop |
| O | Y |
| P | Z |

In one non-limiting example, the techniques may be applied to encode an EAN-8 barcode, so only the numerals 0-9 may be needed. Two characters may be reserved for “Start” (i.e., character “L”) and “Stop” (i.e., character “N”). The “Start” character may be the leftmost character in a character string while the “Stop” character may be the rightmost character in a character string. An EAN-8 barcode has 8 characters, so there are 10 characters in total, including the “Start” and “Stop” characters (or bits). Triangles are used mostly for the “dots” although squares are used as alternatives for two designs.

For the multi-level coding scheme, there may be two types, in the form of a “No-Guard” variation, and a “Guard” variation. For the “No-Guard” variation, the geometry or configuration may be as shown in FIG. 6C, where each character (e.g., character n 645) may be about 2.5 mm wide, with a 1 mm inter-character spacing.

For the “Guard” variation, the “Start” and “Stop” bits are not used. Instead, a vertical “guard” void of unprocessed material about 0.5 mm in width is inserted before each character to act as a “column”. A (long) vertical void (e.g., a rectangle) is preferable due to its scannability, although it should be appreciated that the “guard” void may be of any other shapes. Only 8 character bits may thus be needed. There may be a 0.5 mm space between the guard and either character, where the guard may be sandwiched between two characters.

Bit-Depth Encoding

FIG. 6D shows a bit depth coding method, according to various embodiments. This scheme uses small height differences at minimum resolvable resolution. Each character (for example, two characters are shown: character 1 650 and character 2 652) may be encoded in a 3×2 matrix. Each 3×2 matrix may be defined into six regions. Using the character 650 as an example, one of the regions may be identified as region “6” and represented by 656. Various characters may be encoded in such 3×2 matrix, for example, at least 22 different characters. More characters may be possible although some may be redundant from the ultrasonic point of view. Each matrix may be about 1.5 mm long and 1 mm deep. This may allow full EAN-13 barcodes.

FIG. 6D shows the arrangements or patterns for 10 digits or characters. However, it should be appreciated that, while not shown, other arrangements may also be possible, for the same 10 digits and/or for other characters/digits not illustrated. Each arrangement for the characters may include one or more voids (or coded volumes) (as represented by dark areas, and represented by 658 for one such dark area for the character “0” as an example) and one or more volumes of processed object (or base/metal) material (as represented by light areas, and represented by 659 for one such light area for the character “0” as an example).

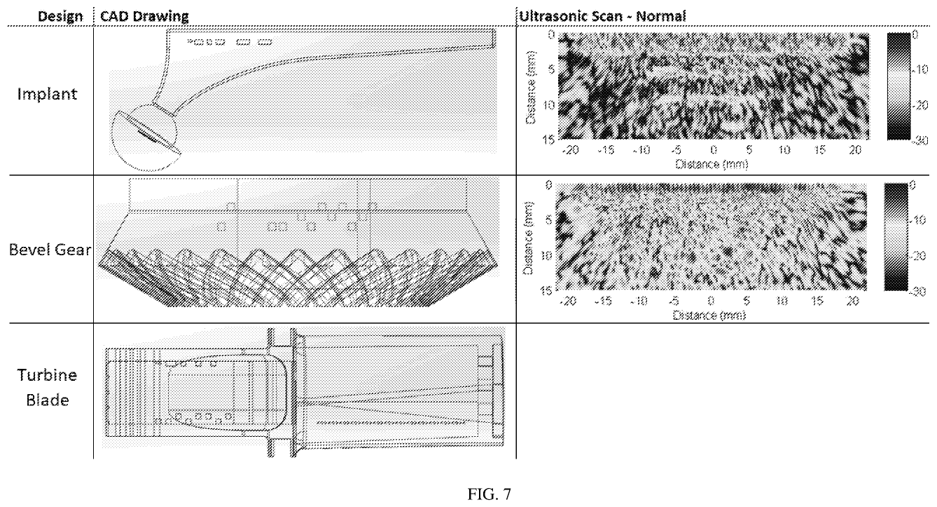

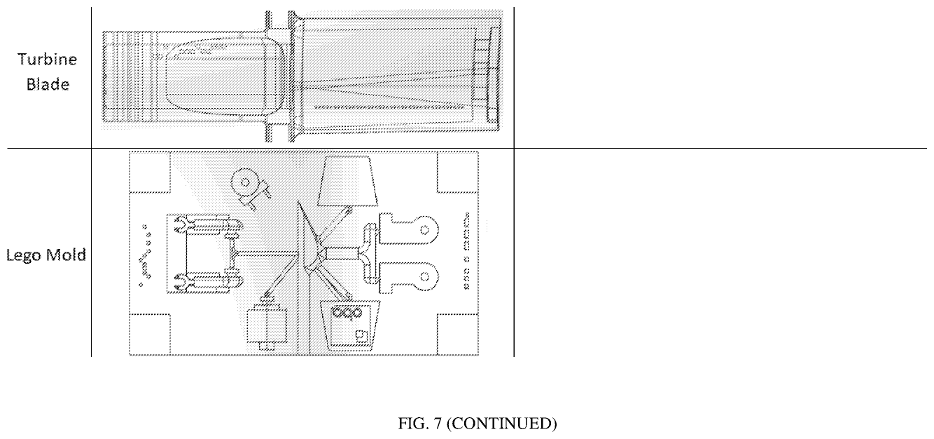

In Example 3, actual parts of different designs are produced or printed. The designs replicate codes developed in Example 2. However, the size of certain codes are enlarged from about 1 mm to about 1.5 mm to ensure better clarity, and will be described further below. TABLE 4 and FIG. 7 show examples of designs of various objects with codes, where FIG. 7 further shows the corresponding ultrasonic scanned images. An example of the scanning process will be described further below. Due to the complexity of the object shape/configuration, it may not be possible to obtain scanned images of some of the objects.

TABLE 4
DESIGNS OF VARIOUS OBJECTS WITH CODES FOR EXAMPLE 3

| | Lv | Wv | | Di | Ls | | | |
|---|---|---|---|---|---|---|---|---|
| Design Number | (mm) | (mm) | Dv | (mm) | (mm) | Dsep | Fill | Pattern |
| Lego Man Top Insert | 5 | 2 × 2 | Linear Bit | 5 | 1.5 | n/a | yes | 11011011 10010101 |
| Lego Man Top Insert | 5 | 1.5 × 1.5 | Multi Bit | 5 | 1.5 | n/a | yes | 69082224 |
| Hip Implant | 5 | 1.5 × 1.5 | Linear Bit | 5 | 1.5 | n/a | yes | 11010110 11100111 |
| Bolt | 5 | 1.5 × 1.5 | Multi Bit | 5 | 1.5 | n/a | yes | HLHLLHLHL |
| Turbine Blade | 5 | 1.5 × 1.5 | Linear Bit | 5 | 1.5 | n/a | yes | 1101 1001 |
| Turbine Blade | 5 | 1.5 × 1.5 | Multi Bit | 5 | 1.5 | n/a | yes | LHLLHLHH |
| Turbine Blade | 5 | 1.5 × .1.5 | Multi Bit | 5 | 1.5 | n/a | yes | Start 6908X Stop |
| Bevel Gear | 5 | 1.5 × 1.5 | Multi Bit | 5 | 1.5 | n/a | yes | ZW1278YX |

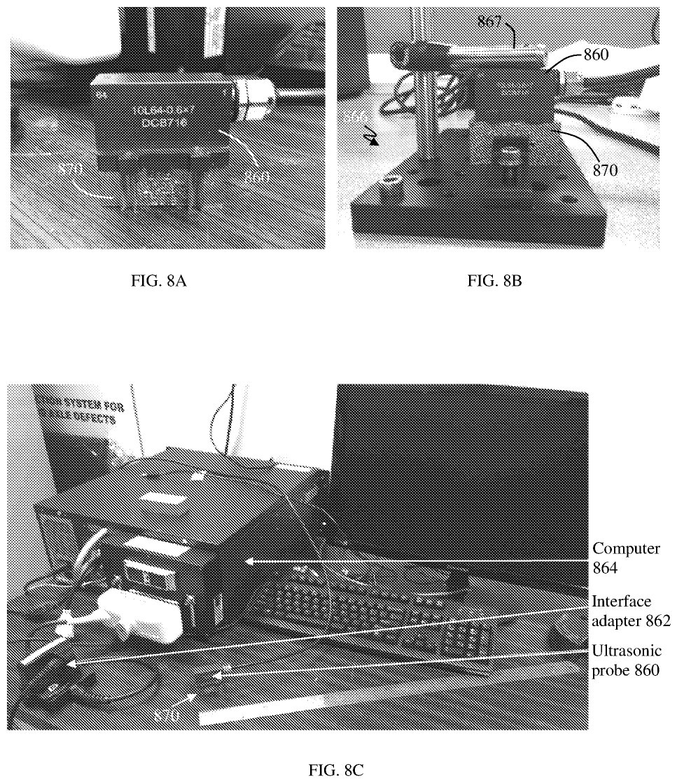

Referring to FIGS. 8A to 8C, an example of a measurement setup for scanning may include an ultrasonic probe 860, an interface adapter 862, a computer 864, and a jig (or support structure) 866 to hold the specimen (or object to be scanned) 870 in place during scanning. FIGS. 8A and 8B respectively show the ultrasonic probe 860 scanning the printed object 870 without and with the jig 866, while FIG. 8C show the full setup of the ultrasonic scanner system. The probe 860 may be modular and may be changed to other types of probe that may use the same interface 862. As non-limiting examples, probes of 5 MHz and 10 MHz may be used.

The probe 860 may have a fixed scanning frequency of about 10 MHz. A higher frequency may be able to pick up (or detect) more voids, though more noise may possibly be picked up too. The probe 860 may have an array of 64 nodes where ultrasonic signals may be fired off and received, similar to that of a sonar. Voids may be detected and the data collected may be sent over to the computer 864 to be processed, for example, in Matlab.

The ultrasonic machine or system may scan voids that are deeper than 5 mm into the object or work piece. However, if the depth of the voids is too deep, the image reflected may be noisy. As non-limiting examples, the voids may be placed or located within a 5 mm to 20 mm depth zone to ensure readability by the scanner or probe.

Before scanning, the user has to prepare the surface of the object to be scanned by grinding and polishing to ensure that the surface is as smooth as possible. An ultrasonic gel may be placed over the scanning surface to act as a medium, and also to remove as much air pockets as possible. Air pockets may result in high reflection, which in turn may smother out any results that are around that particular region having the air pockets.

Referring to FIG. 8B, to ensure a consistent pressure being applied, the jig 866 may be provided to allow the specimen 870 to be located in place. The probe 860 may then sit on top of the surface to be scanned. A metal rod 867 may then be lowered and weight is applied by gravity to hold the probe 860 in place.

FIG. 9 shows a process flow 980 for 3D printed EIMs (Embedded Identifier Modules). At 981, encoding starts with the user preparing one or more CAD (computer-aided design) files with the codes. These codes may be embedded into the object itself as a solid model. Next, at 982, the user may convert the CAD model into STL (stereolithography) format before sending it to the build processor at 983, which slices the file for the (printing) machine to print. After that is done, preparation of print parameters, materials, and etc. has to be done before printing. At 984, printing is carried out. After the print is completed, post processing at 985 may be used to clean up and polish the surface for scanning. Finally, at 986, the user may scan the printed object to obtain scanned images and results.

There are some challenges involved. As there is no software available in the market that does the auto encoding for the end user, encoding has to be done manually. Further, STL files are hard to work with due to their non-parametric nature, which adds a further difficulty. However, CAD software has auto table generation, which generates void sizes and design, if the variables are defined, for a same part with variable void sizes and position. Examples of the voids information are as provided in TABLES 1, 2 and 4.

The results obtained, including schematics and scanned results, are as shown in FIGS. 4B, 5B and 7. Some representative results from Examples 1 to 3 are described below.

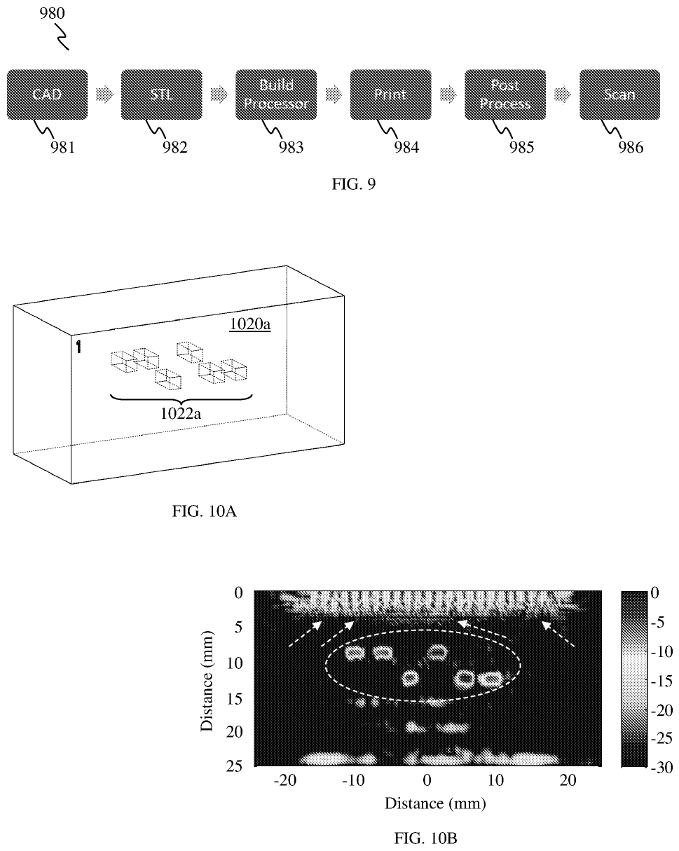

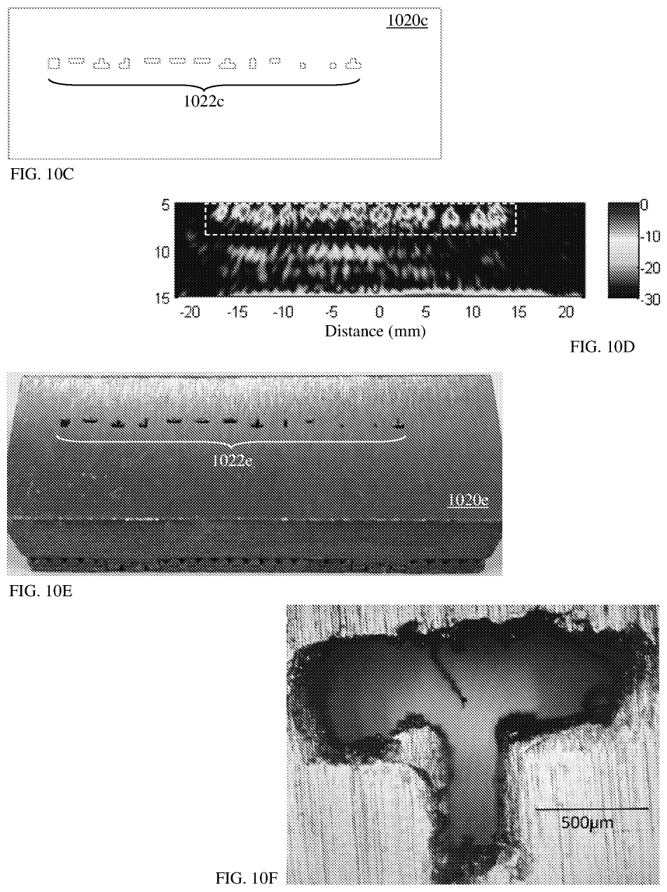

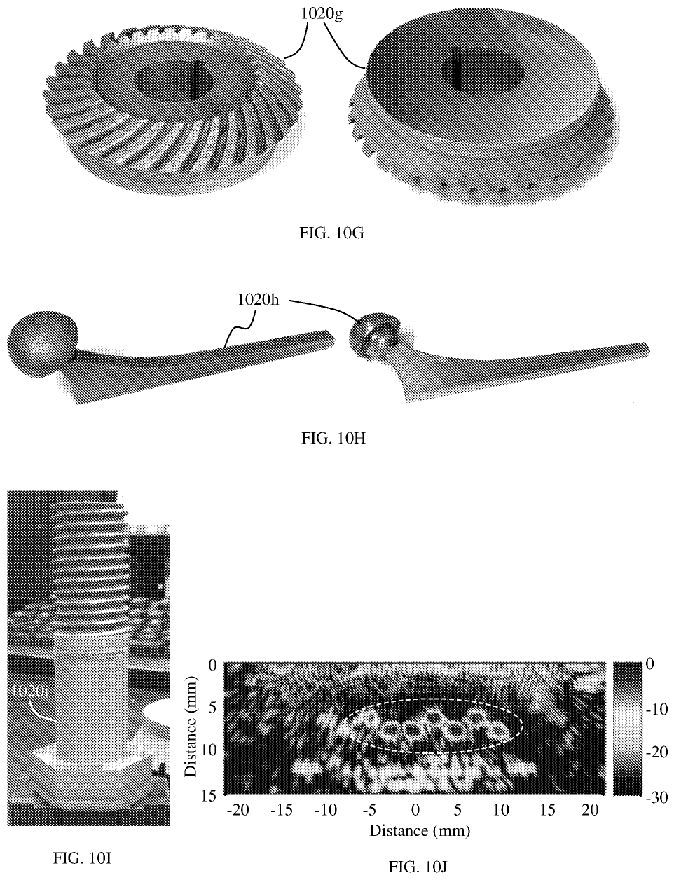

FIGS. 10A and 10B show the CAD model and the scanned model (scanned image) comparison for design 1 of Example 1. The CAD model shows a block 1020a with an arrangement 1022a of voids. In FIG. 10B, for clarity purpose, a dashed ellipse is included to indicate where the corresponding voids are. The voids, in particular the central regions of the voids, are biased towards 0 on the accompanying scale of FIG. 10B.

It was found that any voids that are located within 5 mm from the scanning surface may not be readable. This may be due to reflections that occur at the interface between the ultrasonic probe and the top surface of the object, as may be observed in FIG. 10B and representatively indicated by the dashed arrows. To minimise this effect, encodings may be placed at or beyond a certain threshold depth into the object (or from the scanning surface of the object), for example, at or beyond the 5 mm depth.

As may be observed, the voids are easily detectable and inference from the results may be interpreted into a set of codes. The results for the various designs for Example 1 are shown in FIG. 4B.

FIGS. 10C and 10D show the CAD model and the scanned model (scanned image) comparison for design B23 of Example 2. The CAD model shows a block 1020c with an arrangement 1022c of voids. In FIG. 10D, for clarity purpose, a dashed rectangle is included to indicate where the corresponding voids are. The voids, in particular the central regions of the voids, are biased towards 0 on the accompanying scale of FIG. 10D.

For Example 2, smaller voids are designed to reduce the overall space required for embedding them into thinner objects or parts. The results obtained show that it is possible for smaller voids to be printed or produced. However, due to the smaller voids, there are challenges in that the ultrasound resolution may be unable to clearly define the void shapes and sizes compared to those for Example 1.

Some of the objects of Example 2 are sectioned to see the details of the voids that are printed in order to confirm that the voids are of the desired or correct design. FIG. 10E shows an image of an object (EIM) 1020e that has been sectioned to show the void designs (i.e., arrangement 1022e of voids).

As may be observed in FIG. 10E, the voids, which are about 0.5 mm at its thinnest part, is easily replicated through an SLM (selective laser melting) process. However, due to the nature of ultrasound, some of the voids may be blurred or unreadable. This may be improved by considering, for the designs, the shapes and/or sizes of the voids, and also improving the system's ability to read the small voids. The voids of the object 1020e may be observed under a microscope and FIG. 10F shows a 10× zoom microscopy image of one of the voids. The overall geometry is slightly more round as compared to the CAD file. There may be a limitation on the process of how well the SLM is able to produce sharp distinct corners, but these should not limit the readability of the voids.

For Example 3, the voids are enlarged slightly from about 1 mm to about 1.5-2 mm overall for use in actual objects or parts. This may ensure easy readability. However, there may be challenges in obtaining the results due to the presence of noise, which may arise due to the shapes of the objects. Improvement may be obtained by calibrating specific objects to at least one of specific ultrasonic frequency, scanner, and coding optimisation that is required to decode the data. The objects printed for Example 3 include, but not limited to, mold, turbine blade, bevel gear, bolt, and hip implant.

FIG. 10G show images of a printed bevel gear 1020g in various views, while FIG. 10H show images of a printed hip implant 1020h in various views.

FIG. 10I shows a printed bolt 1020i embedded with an identification code, while FIG. 10J shows the corresponding scanned image of the code. In FIG. 10J, for clarity purpose, a dashed ellipse is included to indicate where the voids defining the code are. The voids, in particular the central regions of the voids, are biased towards 0 on the accompanying scale of FIG. 10J.

The types of objects for printing are selected on the consideration that they have a flat surface that may be used for easy scanning. Information on the voids are provided in TABLE 4. Due to the higher complexity of the printed objects of Example 3, there may be challenges in obtaining the corresponding scanned images.

As described, the technologies disclosed herein may allow printing of voids even in the case where the void size is small. Nevertheless, the mechanical performance of the printed objects may be taken into consideration when designing the voids. It may be necessary that the surface of the object for scanning is relatively flat and smooth so that clearer results may be obtained from the scanning process. This may also be further improved by using a suitable scanning device or probe. The code used to control and extract the void position is suitable for stainless steel 316L and aluminium, although the code (whether unmodified or modified) may also be used for other materials. The code may be edited or modified or adapted to match the actual speed of sound in the object to be scanned or tested.

It should be appreciated that the techniques described herein may be used with a number of different additive manufacturing methods. As one example, the additive manufacturing technique/method may be a selective laser sintering technique, where the object material is powder, such as polymeric powder. As another example, the additive manufacturing technique/method may be a selective laser melting technique, where the object material is a metallic powder. As a further example, the additive manufacturing technique/method may be a stereolithographic manufacturing process, where the object material is polymeric liquid and the coded volumes are formed to enclose unprocessed polymeric liquid. As another further example, the additive manufacturing technique/method may be a multi jet fusion manufacturing process, where the object material is powder.

While the technologies disclosed herein may be employed across various applications (including, for example, in automotive, medical and aerospace industries where customised products may be required), three broad use may be identified: Authentication, Certification, and Serialization.

Authentication is the need for objects or parts to have provenance that they were made by a particular company or are owned by a particular entity. Possible applications include replacement parts (e.g., automotive, industrial, etc.), aerospace (e.g., turbine blades, fuel pumps, etc.), standard medical parts, general industrial parts (e.g., O&G (Oil and gas), pumps, etc.), clothing, packaging, medicine/pills, ownership tracking, etc.

Certification has more to do with how the objects were made, for example, whether and which specific industry or government standards were met. Possible applications include fasterners, custom medical parts (e.g., pacemakers), food, etc.

Serialization allows for tracking of objects or parts in a manufacturing or assembly context. It may allow parts to be traced back to a specific lot or date of manufacture, and to keep track of the number of parts shipped, etc. Applications include date/time/location stamp, supply chain management, etc.

Of the three use cases discussed above, Authentication appears to be the area that is least served by existing technologies such as RFID and barcode. Therefore, the technologies disclosed herein relating to embedded identifier module (EIM) may be used for Authentication. Based on the technologies and processes of EIM, four areas that may likely be helped by EIM may include toys, auto parts, aerospace, and weapons.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of additive manufacturing of an object using object material, the method comprising:
forming the object by processing some of the object material; and
forming an object identifier by forming a pattern comprising at least one coded volume within an internal volume of the object, each of the at least one coded volume enclosing unprocessed object material.

2. The method as claimed in claim 1, wherein the pattern is formed by forming a first coded volume at a first location in the internal volume of the object, the first coded volume being disposed relative to a reference location, the location of the first coded volume relative to the reference location being representative of a character associated with the pattern.

3. The method as claimed in claim 2, wherein the pattern is formed by forming further coded volumes at further locations in the internal volume of the object, the location of the further coded volumes relative to the reference location being representative of the character associated with the pattern.

4. The method as claimed in claim 2, wherein the reference location is a reference coded volume disposed within the internal volume of the object or on an external surface of the object.

5. (canceled)

6. The method as claimed in claim 1, wherein the coded volumes are formed to form a multi-dimensional array.

7. The method as claimed in claim 6, comprising forming a pattern defining a start character.

8. The method as claimed in claim 6, comprising forming a pattern, the pattern having a guard encoded volume for each character.

9. The method as claimed in claim 6, wherein the coded volumes are formed in a three-dimensional matrix.

10. The method as claimed in claim 1, wherein the coded volumes are arranged in a pattern representative of plural characters,
the method comprising forming a pattern of coded volumes for each of the plural characters.

11. The method as claimed in claim 1, comprising forming an object identifier which encodes a character based on at least one of a dimension or a volume of the coded volume.

12. The method as claimed in claim 1, comprising forming an object identifier which includes a character based on a shape of the coded volume.

13. The method as claimed in claim 1, wherein the additive manufacturing method comprises a selective laser sintering technique, and wherein the object material comprises powder.

14. (canceled)

15. The method as claimed in claim 1, wherein the additive manufacturing method comprises a selective laser melting technique, and wherein the object material comprises a metallic powder.

16. The method as claimed in claim 1, wherein the additive manufacturing method comprises a stereolithographic manufacturing process, and wherein the object material comprises polymeric liquid, and wherein the method comprises forming coded volumes that enclose unprocessed polymeric liquid.

17. The method as claimed in claim 1, wherein the additive manufacturing method comprises multi jet fusion manufacturing process, and wherein the object material comprises powder.

18. The method as claimed in claim 1, wherein the processed object material has a first density and the unprocessed object material has a second density, the first density being different from the second density.

19. The method as claimed in claim 1, wherein each of the coded volumes has internal surfaces, each of the internal surfaces being disposed at least a minimum distance from an external scanning surface of the object.

20. The method as claimed in claim 1, wherein each of the coded volumes has internal surfaces that are roughened.

21. (canceled)

22. A method of scanning an object identifier formed using the method as claimed in claim 1, the method of scanning comprising:
scanning the object identifier with a scanner and acquiring imaging information therefrom.

23. The method as claimed in claim 22, wherein the scanner comprises an ultrasonic scanner, or a CT scanner, or an X-ray scanner.

24. (canceled)

25. (canceled)
